(19) United States
(12) Patent Application Publication
(10) Pub. No.: US 2026/0079367 A1
(43) Pub. Date: Mar. 19, 2026

(54) LIQUID CRYSTAL DISPLAY DEVICE

(71) Applicant: SHARP KABUSHIKI KAISHA, Osaka (JP)

(72) Inventors: Masanobu MIZUSAKI, Osaka (JP); Kazuhito MATSUMOTO, Osaka (JP); Shinpei HIGASHIDA, Osaka (JP); Sumire NAGOYA, Osaka (JP); Shinji SHIMADA, Osaka (JP)

(21) Appl. No.: 19/332,396

(22) Filed: Sep. 18, 2025

(30) Foreign Application Priority Data
Sep. 18, 2024 (JP) 2024-160822

(51) Int. Cl. G02F 1/1337; C08G 73/10; C08G 77/18

(52) U.S. Cl. CPC G02F 1/1337; C08G 73/1042; C08G 73/1071; C08G 73/1078; C08G 73/1085; C08G 77/18

(57) ABSTRACT

A liquid crystal display device includes: a pair of substrates; a liquid crystal layer held between the pair of substrates; and an alignment film arranged between one substrate of the pair of substrates and the liquid crystal layer. The one substrate includes a step on a surface that is in contact with the alignment film. The alignment film includes a base layer arranged adjacent to the one substrate and a liquid crystal alignment layer arranged adjacent to the liquid crystal layer. The base layer and the liquid crystal alignment layer each have a structure derived from a crosslinking material represented by the following structural formula (1):

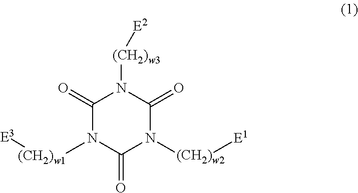

wherein E¹, E², and E³ each independently represent an amino, methyl amino, or hydroxy group, and w1, w2, and w3 each independently represent an integer of 1 or greater and 18 or less.

### CROSS-REFERENCE TO RELATED APPLICATIONS

The present application claims priority under 35 U.S.C. § 119 to Japanese Patent Application No. 2024-160822 filed on Sep. 18, 2024, the contents of which are incorporated herein by reference in their entirety.

### BACKGROUND OF THE INVENTION

### Field of the Invention

The present disclosure relates to liquid crystal display devices.

### Description of Related Art

Liquid crystal display devices are display devices utilizing a liquid crystal composition to display images. A typical display method thereof involves irradiating a liquid crystal panel, which includes a liquid crystal composition sealed between a pair of substrates, with light from a backlight and applying voltage to the liquid crystal composition to change the alignment of the liquid crystal material, thereby controlling the amount of light transmitted through the liquid crystal panel. Such liquid crystal display devices feature a thin profile, light weight, and low power consumption, and are therefore used in electronic devices such as smartphones, tablet PCs, and automotive navigation systems.

Display methods that are attracting attention for their ability to achieve wide viewing angle characteristics are transverse electric field display modes, in which the display is controlled by rotating the alignment direction of the liquid crystal material mainly in a plane parallel to the substrate surfaces. Examples of the transverse electric field display modes include the in-plane switching (IPS) mode and the fringe electric field switching (FFS) mode. Liquid crystal display devices are known to utilize optical films and liquid crystal alignment layers. For example, JP 2008-089855 A discloses an optical compensation film using a specific compound. WO 2023/013622 discloses a liquid crystal alignment agent containing a specific polyimide precursor or polyimide and a compound having two or more crosslinkable groups. JP 2016-173544 A discloses a liquid crystal display element including a liquid crystal alignment layer formed using a liquid crystal alignment agent that contains a polymer having a weight average molecular weight of 30000 or more.

### SUMMARY

The present disclosure includes the following Disclosures 1 to 14.

### (Disclosure 1)

A liquid crystal display device including:
a pair of substrates;
a liquid crystal layer held between the pair of substrates; and
an alignment film arranged between one of the pair of substrates and the liquid crystal layer,
the one of the pair of substrates including a step on a surface that is in contact with the alignment film,
the alignment film including a base layer arranged adjacent to the one of the pair of substrates and a liquid crystal alignment layer arranged adjacent to the liquid crystal layer,
the base layer and the liquid crystal alignment layer each having a structure derived from a polymer having a crosslinkable functional group,
the base layer and the liquid crystal alignment layer each having a structure derived from a crosslinking material represented by the following structural formula (1):

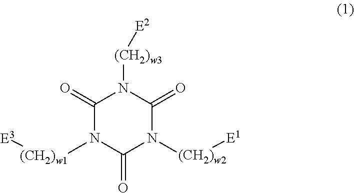

wherein E¹, E², and E³ each independently represent an amino, methyl amino, or hydroxy group, and w1, w2, and w3 each independently represent an integer of 1 or greater and 18 or less.

### (Disclosure 2)

The liquid crystal display device according to Disclosure 1,
wherein w1, w2, and w3 in the structural formula (1) each independently represent an integer of 4 or greater and 18 or less.

### (Disclosure 3)

The liquid crystal display device according to Disclosure 1 or 2,
wherein E¹, E², and E³ in the structural formula (1) each independently represent an amino or methyl amino group.

### (Disclosure 4)

The liquid crystal display device according to any one of Disclosures 1 to 3,
wherein a percentage by weight of the structure derived from a crosslinking material in a total of the structures derived from the respective polymers constituting the base layer and the liquid crystal alignment layer is 20% or more and 80% or less.

### (Disclosure 5)

The liquid crystal display device according to any one of Disclosures 1 to 4,
wherein the step has a height greater than a thickness of the alignment film.

### (Disclosure 6)

The liquid crystal display device according to any one of Disclosures 1 to 5,
wherein the step has a height of 200 nm or greater and 1000 nm or less.

### (Disclosure 7)

The liquid crystal display device according to any one of Disclosures 1 to 6,
wherein the liquid crystal alignment layer is a photoalignment film that has undergone photoalignment treatment.

### (Disclosure 8)

The liquid crystal display device according to any one of Disclosures 1 to 7,
wherein the liquid crystal alignment layer has a structure derived from a polyimide-based, polyamic acid-based, polysiloxane-based, polyacrylic acid-based, or polymethacrylic acid-based polymer that has an epoxy group in a side chain.

### (Disclosure 9)

The liquid crystal display device according to Disclosure 8,
wherein the liquid crystal alignment layer has a structure derived from a polyimide-based or polyamic acid-based horizontal alignment polymer represented by the following structural formula (2) or (3):

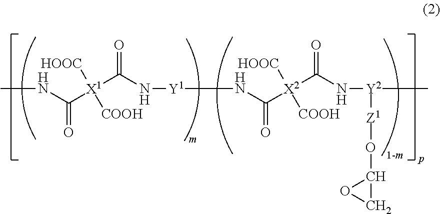

wherein X¹ and X² each independently represent any one of the following structural formulas (X-a1) to (X-a13) and (X-b1) to (X-b4), Y¹ represents any one of the following structural formulas (Y-a1) to (Y-a14) and (Y-b1) to (Y-b8), Y² represents any one of the following structural formulas (Y-c1) to (Y-c16) and (Y-d1) to (Y-d8), Z¹ represents a direct bond with an epoxy group or a linear or branched alkylene group having 1 or more and 12 or less carbon atoms, m represents a value of 0 or greater and 0.5 or less, and p represents an integer of 1 or greater,

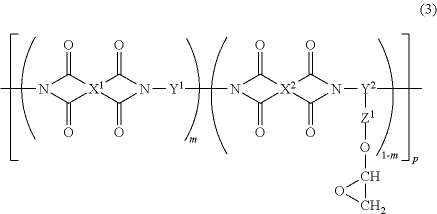

wherein X¹ and X² each independently represent any one of the following structural formulas (X-a1) to (X-a13) and (X-b1) to (X-b4), Y¹ represents any one of the following structural formulas (Y-a1) to (Y-a14) and (Y-b1) to (Y-b8), Y² represents any one of the following structural formulas (Y-c1) to (Y-c16) and (Y-d1) to (Y-d8), Z¹ represents a direct bond with an epoxy group or a linear or branched alkylene group having 1 or more and 12 or less carbon atoms, m represents a value of 0 or greater and 0.5 or less, and p represents an integer of 1 or greater,

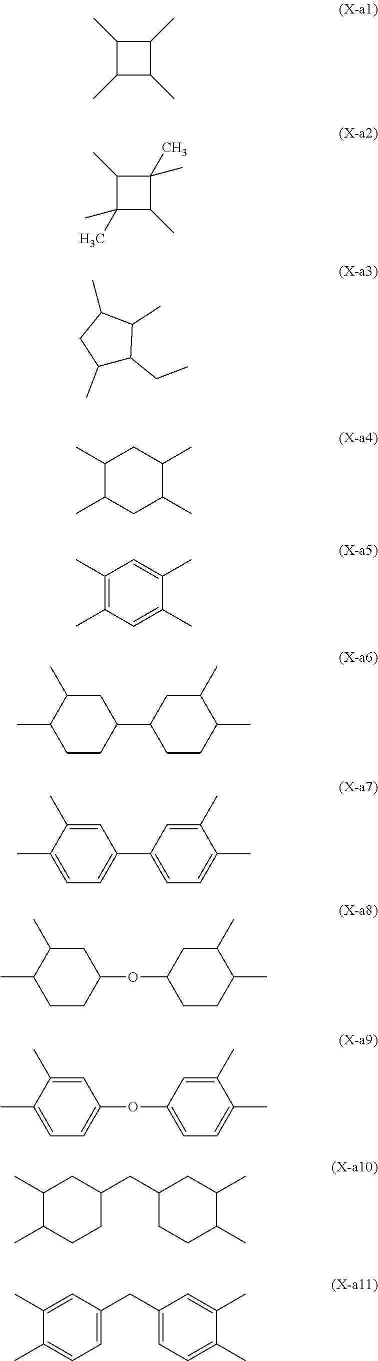

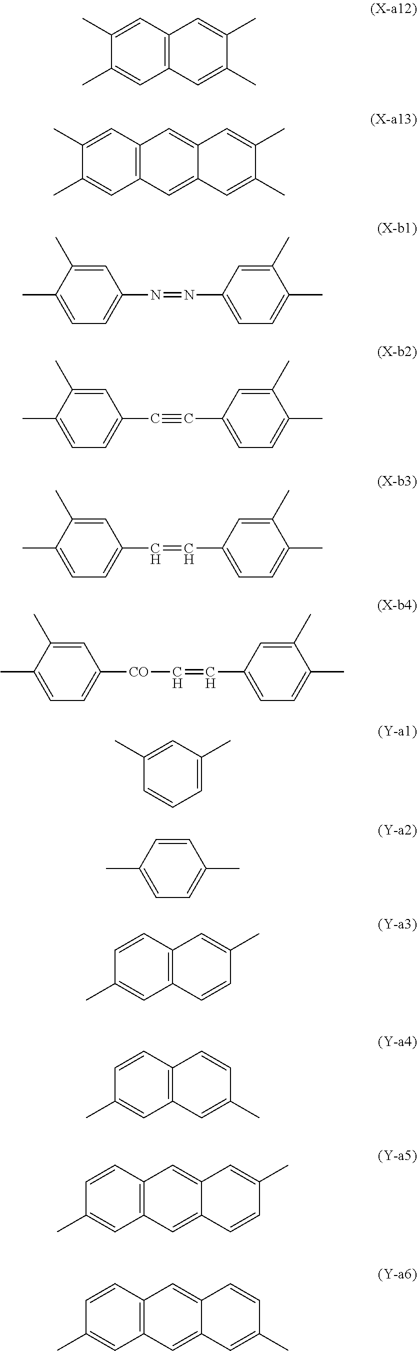

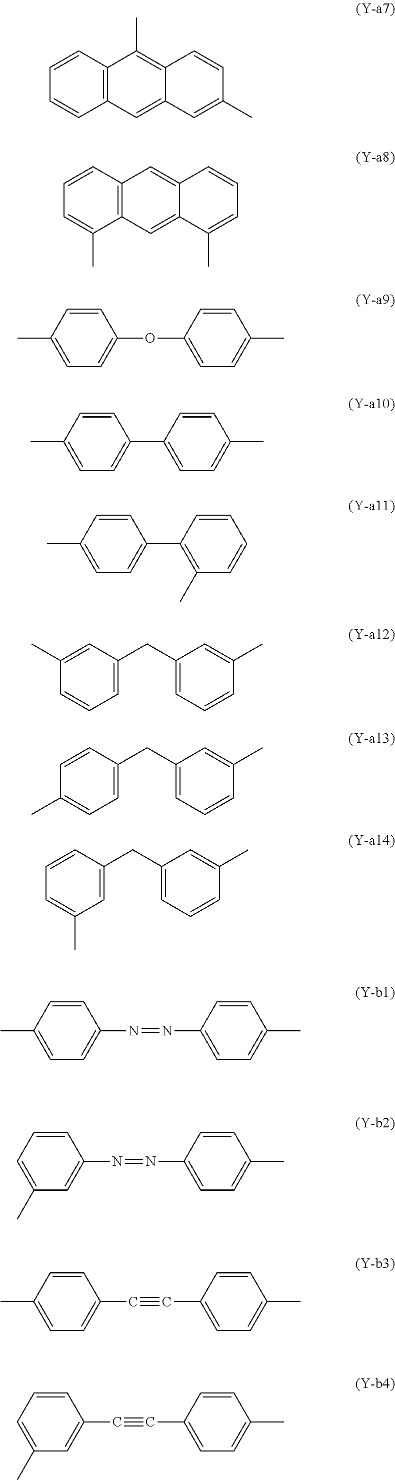

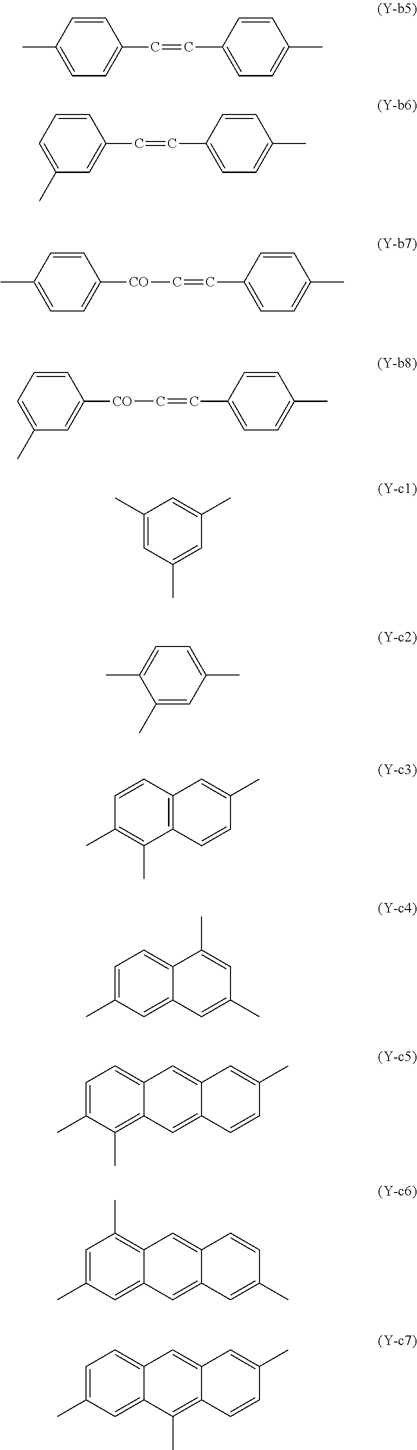

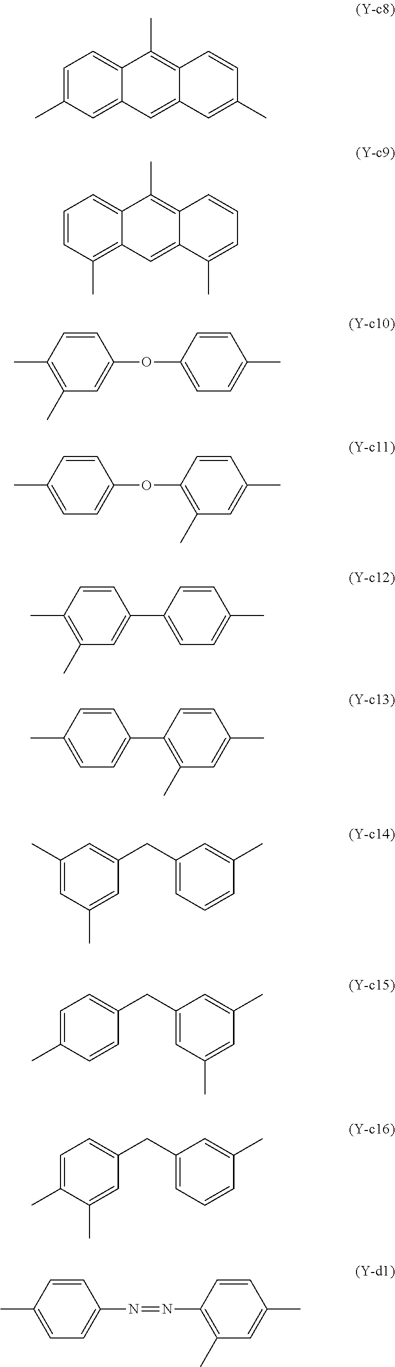

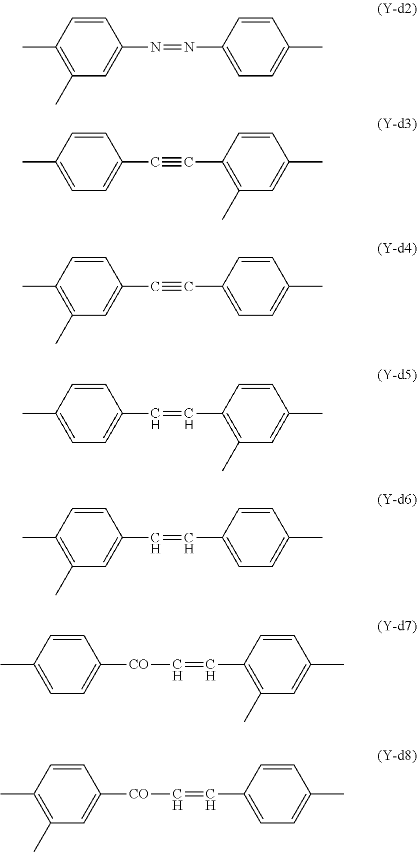

### (Disclosure 10)

The liquid crystal display device according to Disclosure 8,
wherein the liquid crystal alignment layer has a structure derived from a polyimide-based or polyamic acid-based vertical alignment polymer represented by the following structural formula (2′) or (3′):

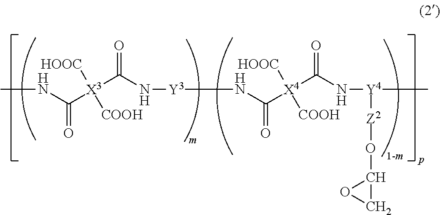

wherein X³ and X⁴ each independently represent any one of the following structural formulas (X-a1) to (X-a13) and (X-b1) to (X-b4), Y³ represents a moiety in which a side chain represented by any one of the following structural formulas (Za-1) to (Z-a21) is bonded to any one of the following structural formulas (Y-c1) to (Y-c16) and (Y-d1) to (Y-d8), Y⁴ represents any one of the following structural formulas (Y-c1) to (Y-c16) and (Y-d1) to (Y-d8), Z² represents a direct bond with an epoxy group or a linear or branched alkylene group having 1 or more and 12 or less carbon atoms, m represents a value of 0 or greater and 0.5 or less, and p represents an integer of 1 or greater,

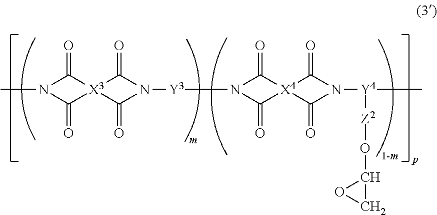

wherein X³ and X⁴ each independently represent any one of the following structural formulas (X-a1) to (X-a13) and (X-b1) to (X-b4), Y³ represents a moiety in which a side chain represented by any one of the following structural formulas (Z-a1) to (Z-a21) is bonded to any one of the following structural formulas (Y-c1) to (Y-c16) and (Y-d1) to (Y-d8), Y⁴ represents any one of the following structural formulas (Y-c1) to (Y-c16) and (Y-d1) to (Y-d8), Z² represents a direct bond with an epoxy group or a linear or branched alkylene group having 1 or more and 12 or less carbon atoms, m is a value of 0 or greater and 0.5 or less, and p represents an integer of 1 or greater,

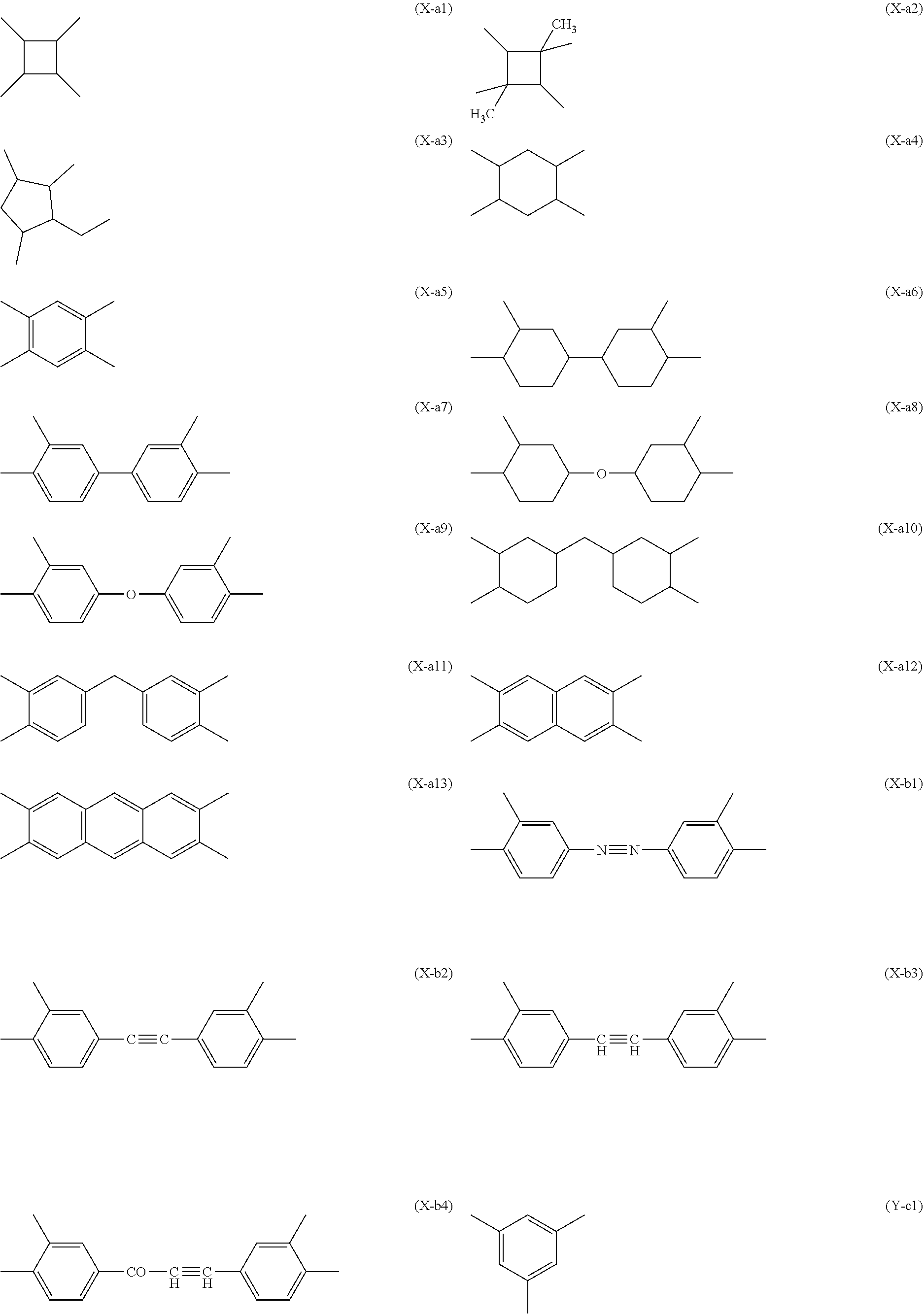

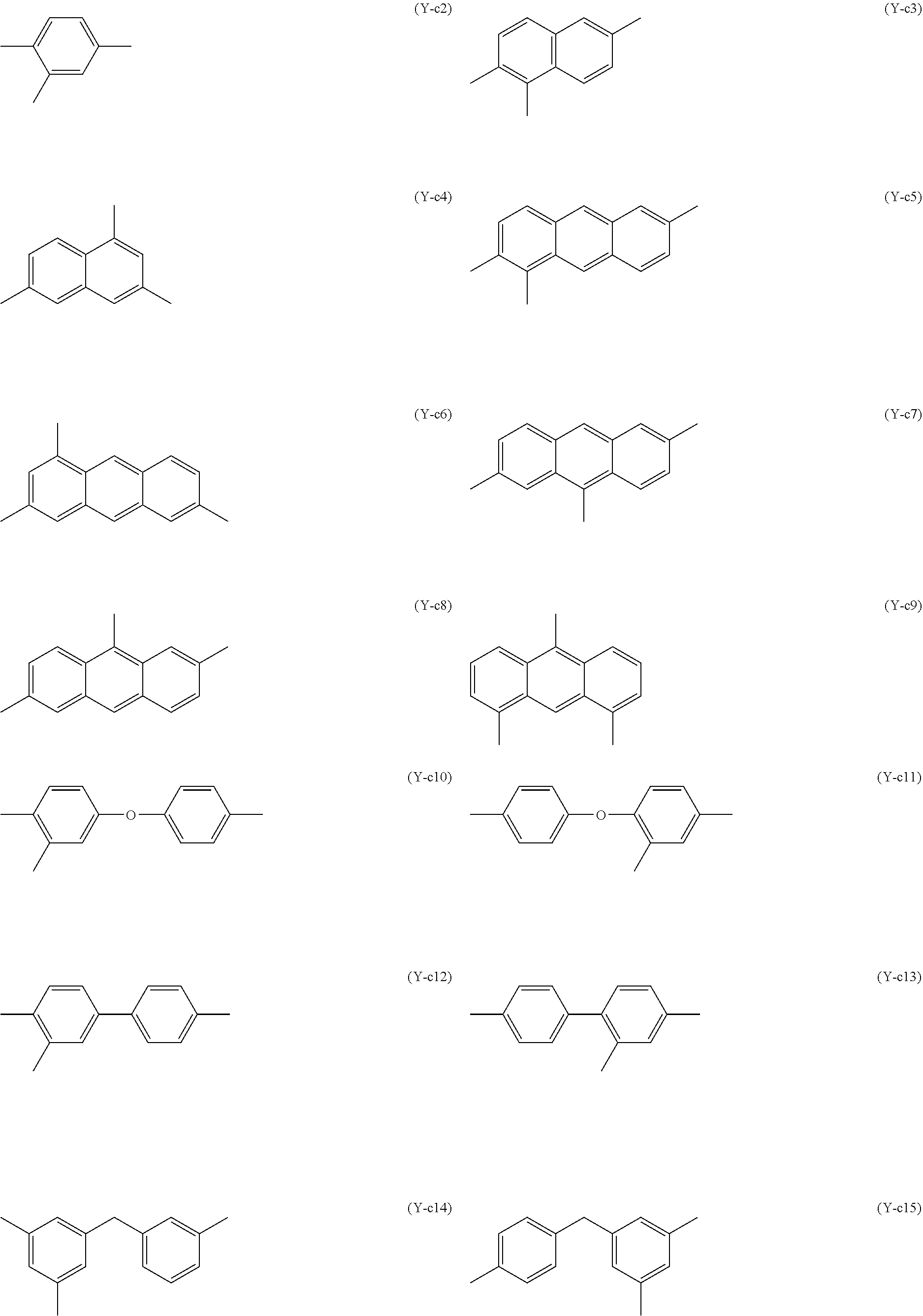

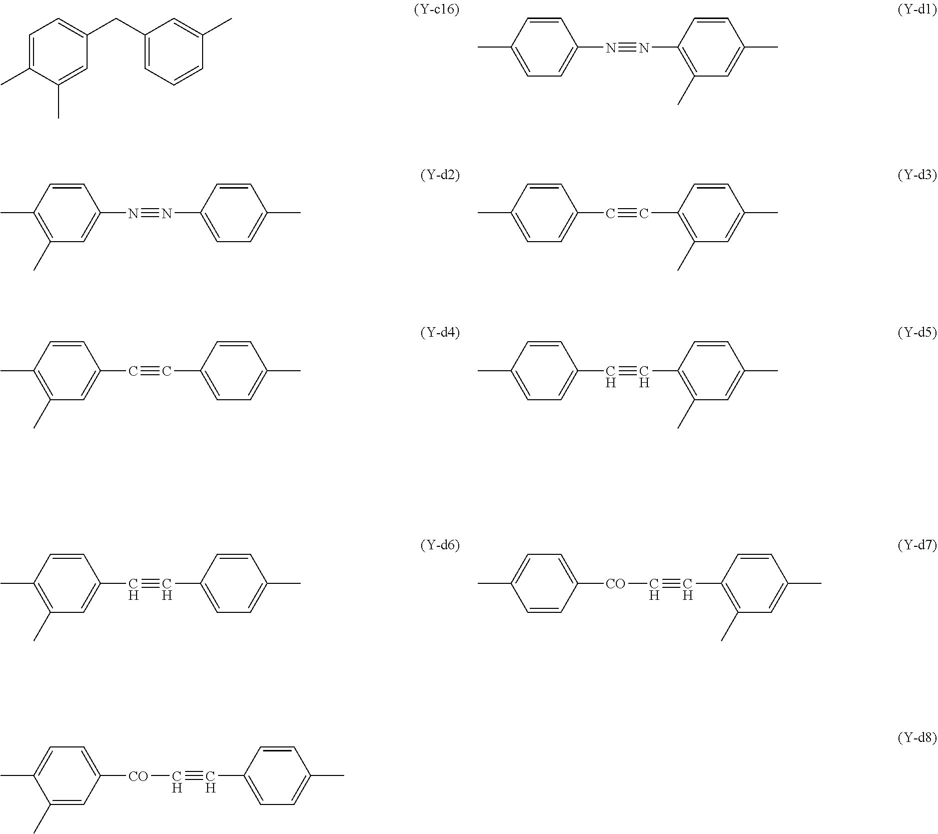

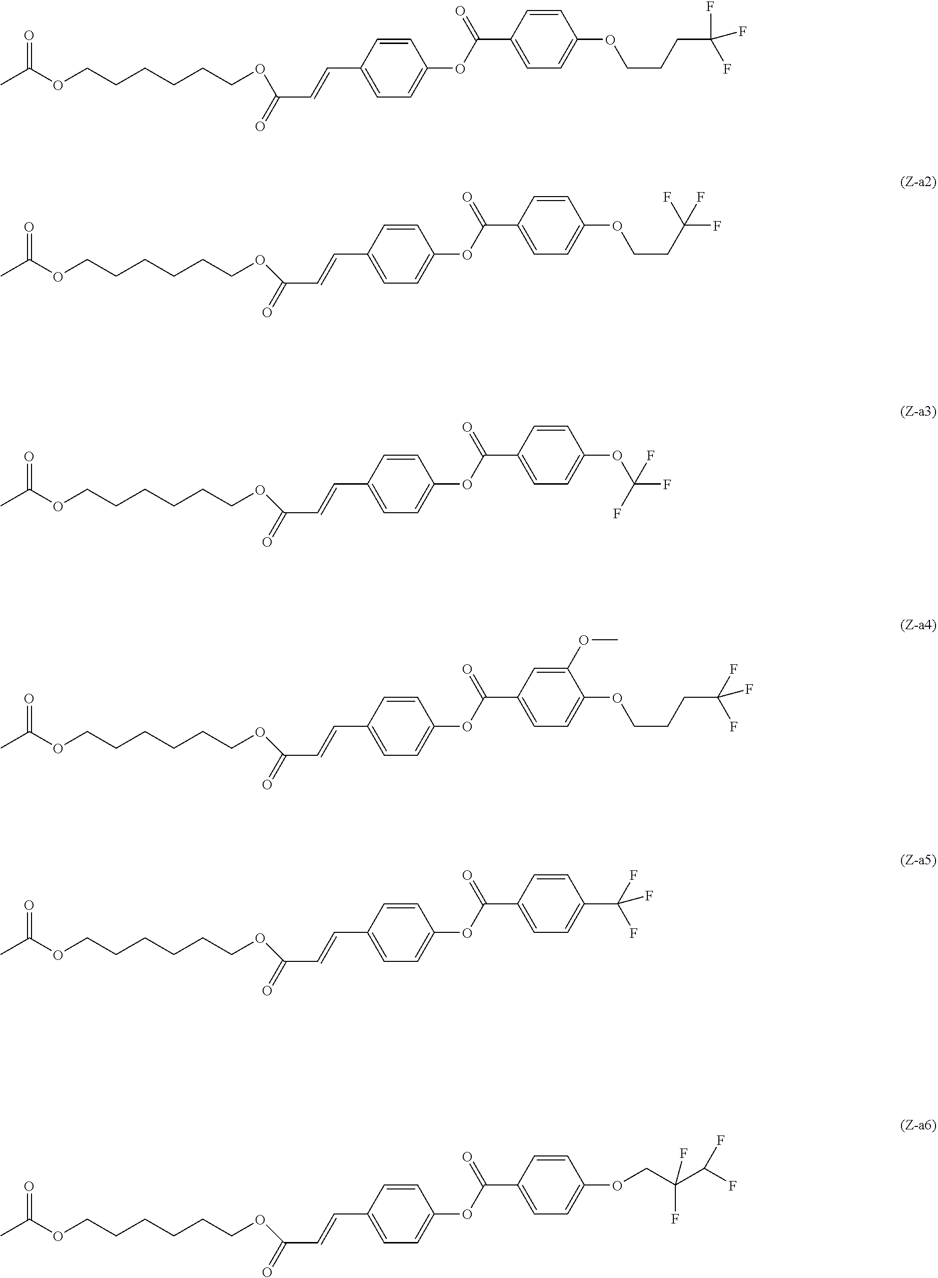 [SMILES: CC(=O)OCCCCCCOC(=O)/C=C/c1ccc(OC(=O)c2ccc(OCCCC(F)(F)F)cc2)cc1 ; CC(=O)OCCCCCCOC(=O)/C=C/c1ccc(OC(=O)c2ccc(OCCC(F)(F)F)cc2)cc1 ; CC(=O)OCCCCCCOC(=O)/C=C/c1ccc(OC(=O)c2ccc(OC(F)(F)F)cc2)cc1 ; COc1cc(C(=O)Oc2ccc(/C=C/C(=O)OCCCCCCOC(C)=O)cc2)ccc1OCCCC(F)(F)F ; CC(=O)OCCCCCCOC(=O)/C=C/c1ccc(OC(=O)c2ccc(C(F)(F)F)cc2)cc1 ; CC(=O)OCCCCCCOC(=O)/C=C/c1ccc(OC(=O)c2ccc(OCC(F)(F)C(F)F)cc2)cc1]

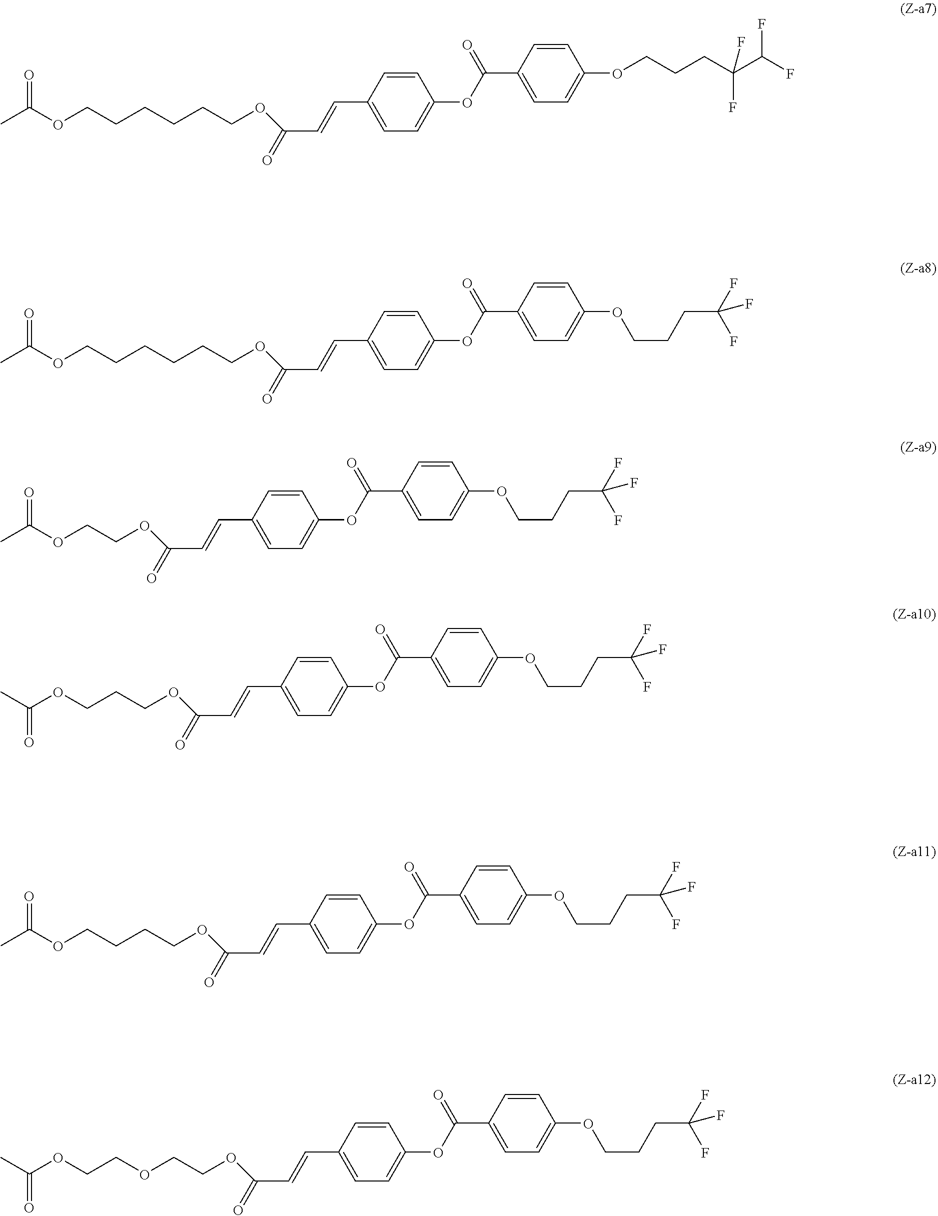 [SMILES: CC(=O)OCCCCCCOC(=O)/C=C/c1ccc(OC(=O)c2ccc(OCCCC(F)(F)C(F)F)cc2)cc1 ; CC(=O)OCCCCCCOC(=O)/C=C/c1ccc(OC(=O)c2ccc(OCCCC(F)(F)F)cc2)cc1 ; CC(=O)OCCOC(=O)/C=C/c1ccc(OC(=O)c2ccc(OCCCC(F)(F)F)cc2)cc1 ; CC(=O)OCCCOC(=O)/C=C/c1ccc(OC(=O)c2ccc(OCCCC(F)(F)F)cc2)cc1 ; CC(=O)OCCCCOC(=O)/C=C/c1ccc(OC(=O)c2ccc(OCCCC(F)(F)F)cc2)cc1 ; CC(=O)OCCOCCOC(=O)/C=C/c1ccc(OC(=O)c2ccc(OCCCC(F)(F)F)cc2)cc1]

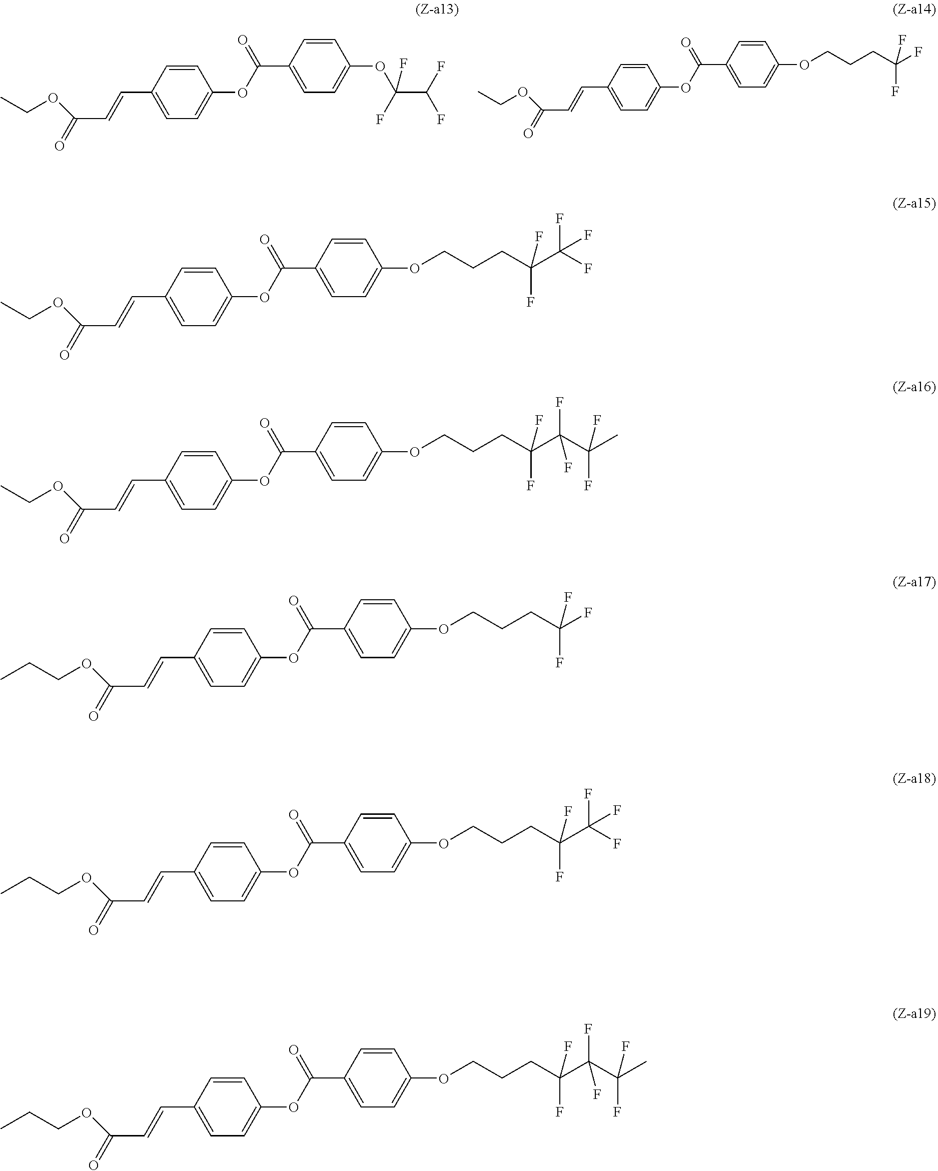

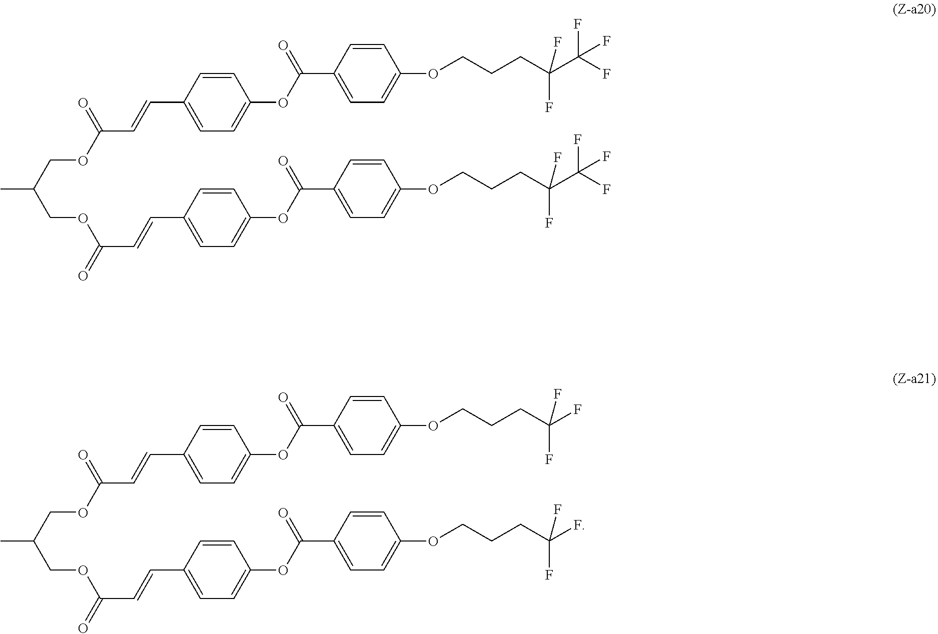 [SMILES: CC(COC(=O)/C=C/c1ccc(OC(=O)c2ccc(OCCCC(F)(F)C(F)(F)F)cc2)cc1)COC(=O)/C=C/c1ccc(OC(=O)c2ccc(OCCCC(F)(F)C(F)(F)F)cc2)cc1 ; CC(COC(=O)/C=C/c1ccc(OC(=O)c2ccc(OCCCC(F)(F)F)cc2)cc1)COC(=O)/C=C/c1ccc(OC(=O)c2ccc(OCCCC(F)(F)F)cc2)cc1]

### (Disclosure 11)

The liquid crystal display device according to Disclosure 8,
wherein the liquid crystal alignment layer has a structure derived from a polysiloxane-based vertical alignment polymer represented by the following structural formula (4) or (5):

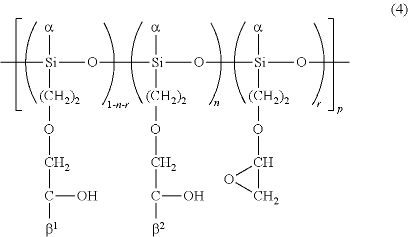

wherein α's each independently represent a hydrogen atom, a methyl group, or a methoxy group, β¹ and β² each independently represent the following structural formula (β-1) or (β-2), n represents a value of 0 or greater and 0.3 or less, r represents a value of greater than 0 and 0.6 or less, and p represents an integer of 1 or greater,

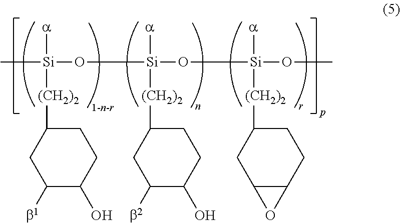

wherein α's each independently represent a hydrogen atom, a methyl group, or a methoxy group, β¹ and β² each independently represent the following structural formula (β-1) or (β-2), n represents a value of 0 or greater and 0.3 or less, r represents a value of greater than 0 and 0.6 or less, and p represents an integer of 1 or greater,

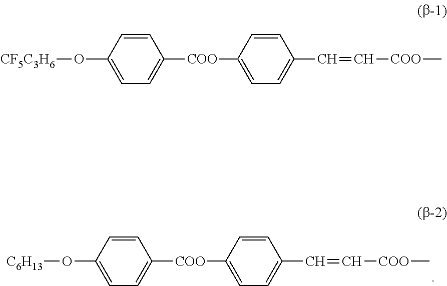

### (Disclosure 12)

The liquid crystal display device according to Disclosure 8,
wherein the liquid crystal alignment layer has a structure derived from a polyacrylic acid-based or polymethacrylic acid-based vertical alignment polymer represented by the following structural formula (6),

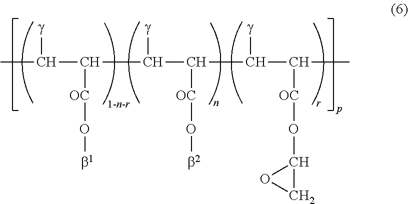

wherein γ's each independently represent a hydrogen atom or a methyl group, β¹ and β² each independently represent the following structural formula (β-1) or (β-2), n represents a value of 0 or greater and 0.3 or less, r represents a value of greater than 0 and 0.6 or less, and p represents an integer of 1 or greater,

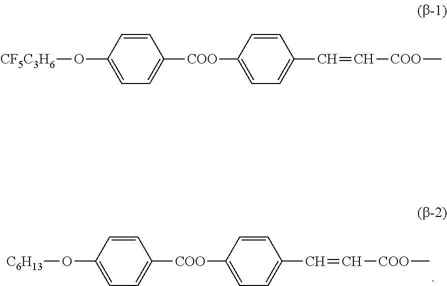

### (Disclosure 13)

The liquid crystal display device according to any one of Disclosures 1 to 12,
wherein the base layer has a structure derived from a polyimide-based or polyamic acid-based polymer represented by the following structural formula (7) or (8),

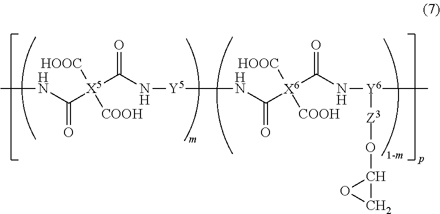

wherein X⁵ and X⁶ each independently represent any one of the following structural formulas (X-c1) to (X-c11), Y⁵ represents any one of the following structural formulas (Y-a1) to (Y-a14), Y⁶ represents any one of the following structural formulas (Y-c1) to (Y-c16), Z³ represents a direct bond with an epoxy group or a linear or branched alkylene group having 1 or more and 12 or less carbon atoms, m represents a value of 0 or greater and 0.5 or less, and p represents an integer of 1 or greater,

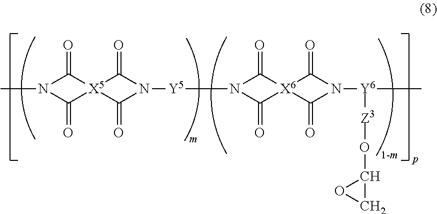

wherein X³ and X⁶ each independently represent any one of the following structural formulas (X-c1) to (X-c11), Y⁵ represents any one of the following structural formulas (Y-a1) to (Y-a14), Y⁶ represents any one of the following structural formulas (Y-c1) to (Y-c16), Z³ represents a direct bond with an epoxy group or a linear or branched alkylene group having 1 or more and 12 or less carbon atoms, m represents a value of 0 or greater and 0.5 or less, and p represents an integer of 1 or greater,

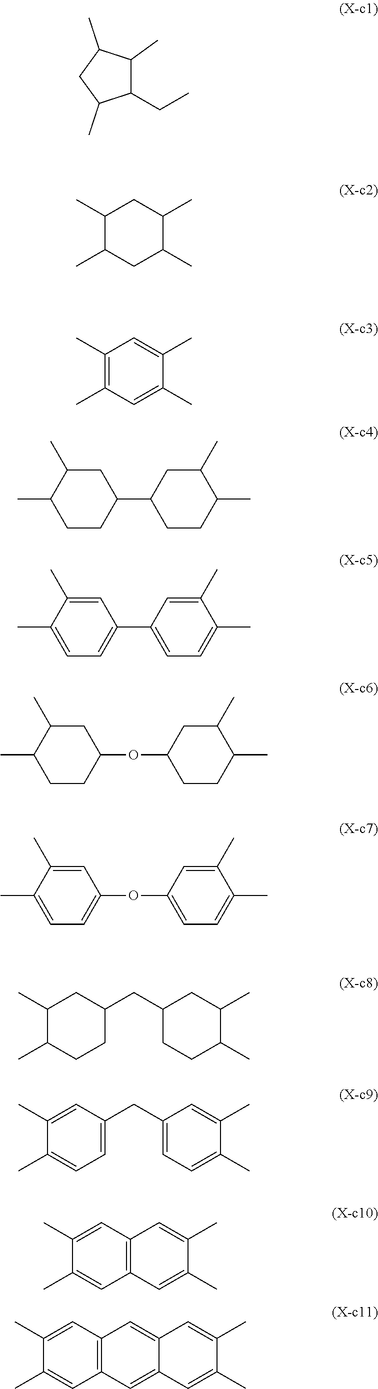

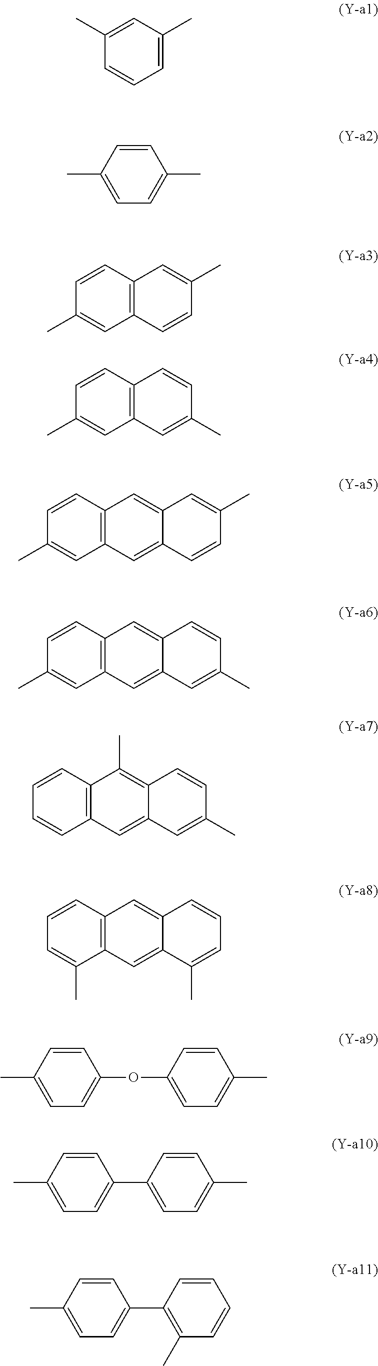

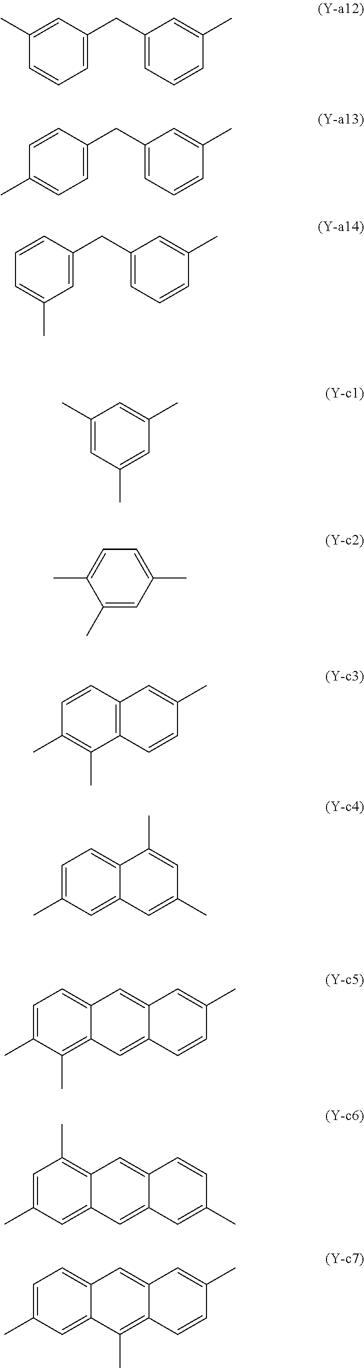

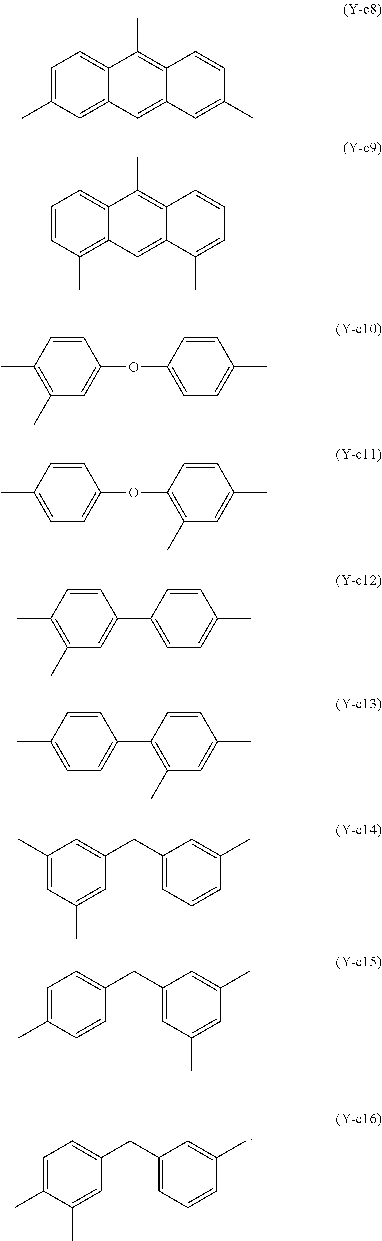

### (Disclosure 14)

The liquid crystal display device according to any one of Disclosures 1 to 12,
wherein the base layer has a structure derived from a polyimide-based or polyamic acid-based polymer represented by the following structural formula (7′) or (8′):

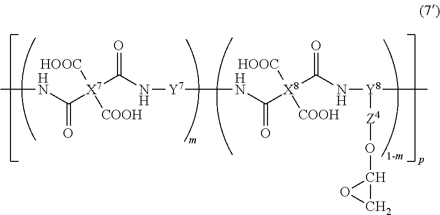

wherein X⁷ and X⁸ each independently represent any one of (X-c1) to (X-c11), Y⁷ represents a moiety in which a side chain represented by any one of the following structural formulas (Z-b1) to (Z-b7) is bonded to any one of the following structural formulas (Y-c1) to (Y-c16), Y⁸ represents any one of the following structural formulas (Y-c1) to (Y-c16), Z⁴ represents a direct bond with an epoxy group or a linear or branched alkylene group having 1 or more and 12 or less carbon atoms, m represents a value of 0 or greater and 0.5 or less, and p represents an integer of 1 or greater,

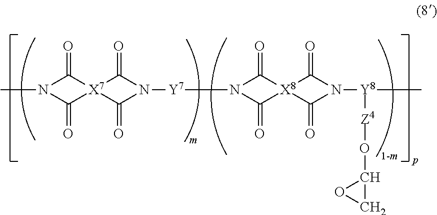

wherein X⁷ and X⁸ each independently represent any one of (X-c1) to (X-c11), Y⁷ represents a moiety in which a side chain represented by any one of the following structural formulas (Z-b1) to (Z-b7) is bonded to any one of the following structural formulas (Y-c1) to (Y-c16), Y⁸ represents any one of the following structural formulas (Y-c1) to (Y-c16), Z⁴ represents a direct bond with an epoxy group or a linear or branched alkylene group having 1 or more and 12 or less carbon atoms, m represents a value of 0 or greater and 0.5 or less, and p represents an integer of 1 or greater,

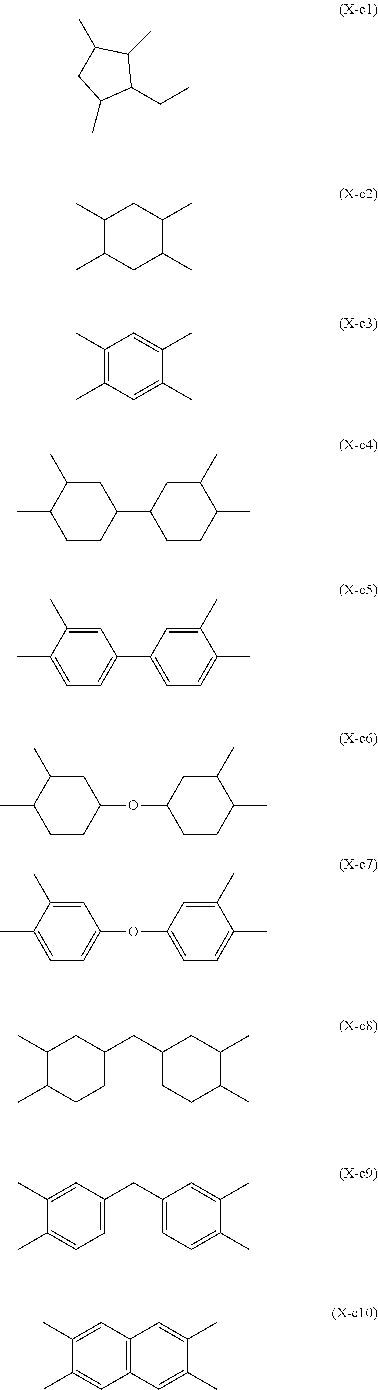

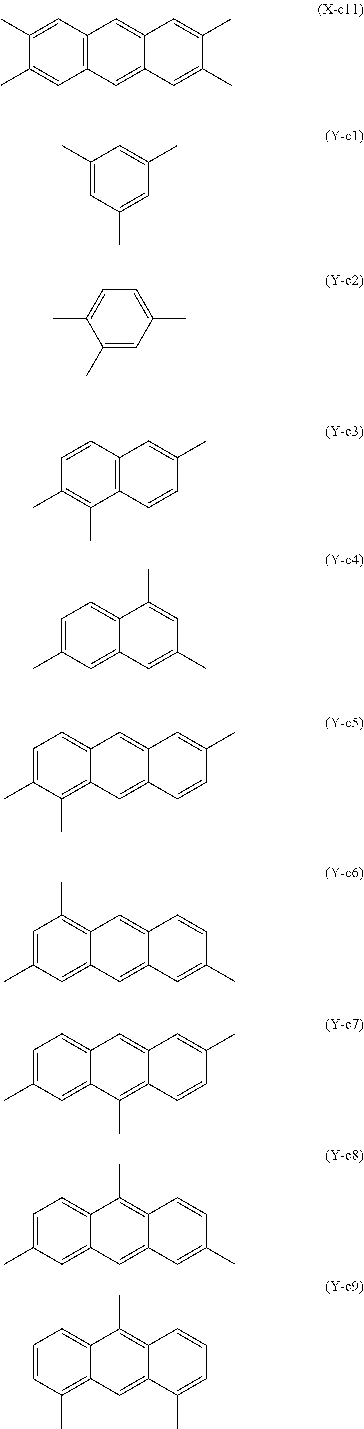

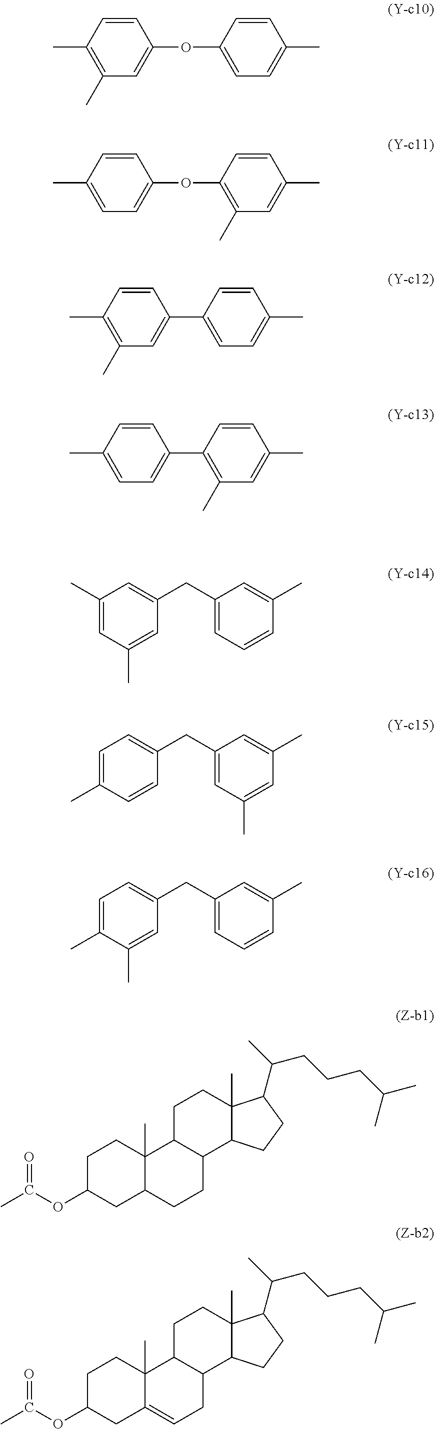

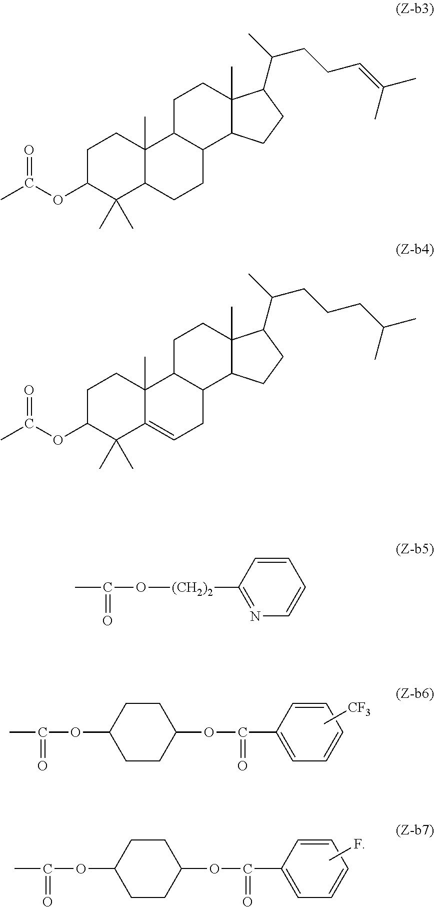

The liquid crystal display device of the present disclosure can reduce or prevent light leakage and a decrease in contrast ratio due to steps of a substrate.

### BRIEF DESCRIPTION OF THE DRAWINGS

FIG. 1 is a plan view schematically showing a substrate having steps in a liquid crystal display device of the present embodiment.

FIG. 2 is a cross-sectional view schematically showing the substrate having steps in the liquid crystal display device of the present embodiment.

FIG. 3 is a cross-sectional view schematically showing a liquid crystal display device in which a conventional alignment film is formed on a substrate having steps, with a focus on the alignment film and its vicinity.

FIG. 4 is a cross-sectional view schematically showing the liquid crystal display device of the present embodiment, with a focus on an alignment film and its vicinity.

### DETAILED DESCRIPTION OF THE INVENTION

In liquid crystal display devices for head mounted displays (HMDs), the display mode is generally the FFS mode to reduce or prevent a color shift within the viewing angle. To secure a sufficient aperture area in response to higher display resolutions, it is advantageous to form color filters on an array substrate. However, the formation of color filters on the array substrate tends to cause color mixing in oblique views, and thus the display area is partially covered with a light-shielding film. In a liquid crystal display device for HMDs in which a light-shielding film is formed, the light-shielding film and electrode slits form projections and recesses on the substrate. Greater steps are formed particularly in portions where the end of the light-shielding film overlaps with the boundary of an electrode slit. When an alignment film is formed in such regions with steps, the alignment azimuth of the liquid crystal molecules may deviate from the alignment azimuth intended by the alignment film, which can undesirably cause light leakage and a decrease in contrast ratio during black display.

In response to the above current states of the art, the present disclosure aims to provide a liquid crystal display device that can reduce or prevent light leakage and a decrease in contrast ratio due to steps of a substrate.

Hereinbelow, an embodiment of the present invention is described. The present invention is not limited to the contents described in the following embodiment, and the design can be modified as appropriate within the scope of the present invention.

The liquid crystal display device of the present embodiment includes a pair of substrates, a liquid crystal layer held between the pair of substrates, and an alignment film arranged between one of the pair of substrates and the liquid crystal layer.

The pair of substrates consists of a TFT substrate and a counter substrate. The liquid crystal layer can be the same as that in a conventional liquid crystal display device.

The one of the pair of substrates includes steps on the surface that is in contact with the alignment film.

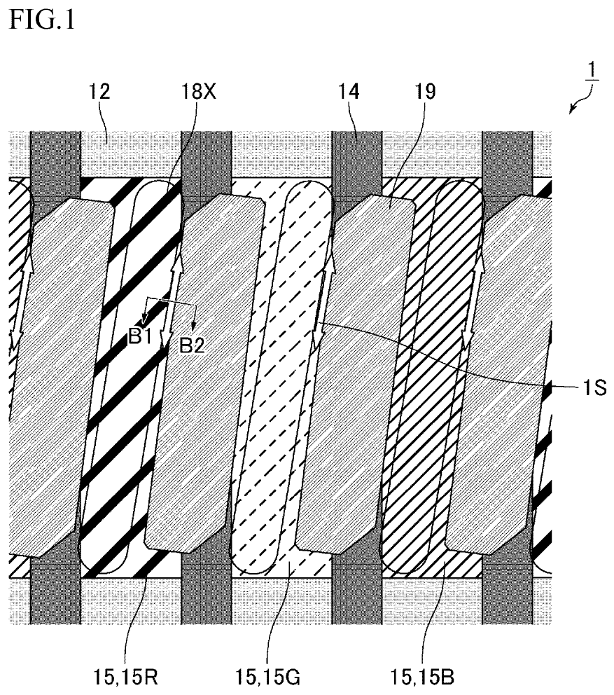

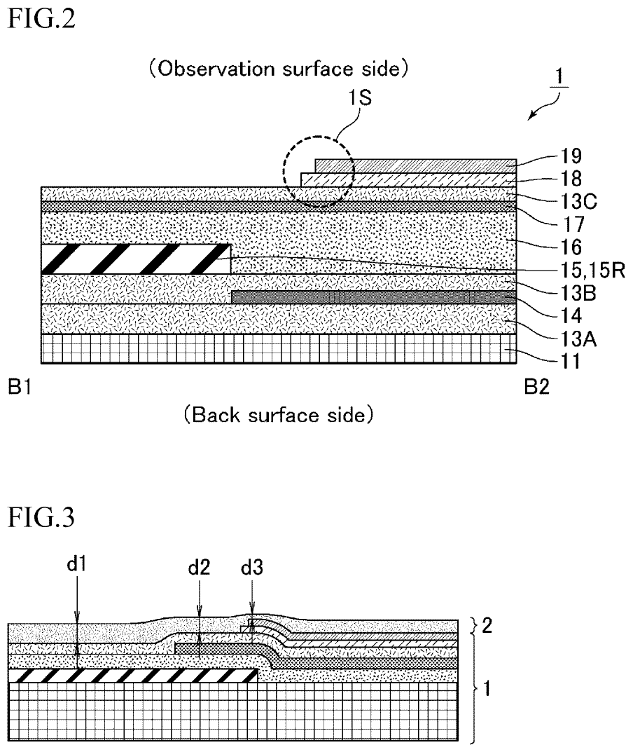

The substrate having steps in the liquid crystal display device of the present embodiment is schematically shown in FIG. 1 as a plan view and FIG. 2 as a cross-sectional view. FIG. 1 omits some layers for clarity. FIG. 2 is a cross-sectional view taken along line B1-B2 in FIG. 1.

As with a substrate in a general liquid crystal display device, a substrate 1 in the liquid crystal display device of the present embodiment includes layers stacked in order from a supporting substrate 11 toward the observation surface side, including a gate line layer 12, a first insulating layer 13A, a semiconductor layer (not shown), a source line layer 14, and a second insulating layer 13B. However, unlike the substrate in a general liquid crystal display device, the substrate 1 in the liquid crystal display device of the present embodiment includes color filters 15 composed of red color filters 15R, green color filters 15G, and blue color filters 15B, which are stacked on the second insulating layer 13B. This structure including the color filters 15 on the supporting substrate 11 (color filter on array (COA) structure) can achieve a sufficient aperture area even when the liquid crystal display device has a high definition. Also, on the color filters 15, a first electrode 17 is stacked via a planarization layer 16, and an insulating layer 13C, a second electrode 18, and a light-shielding film 19 are stacked in this order on the first electrode 17. The second electrode 18 has elongated openings 18X. With the light-shielding film 19 included in the substrate 1, color mixing in oblique views can be reduced or prevented even when the color filters 15 are formed in the substrate 1. Additionally, the substrate 1 includes a region (region within an opening 18X) where the outermost surface is the insulating layer 13C, a region where the outermost surface is the second electrode 18, and a region where the outermost surface is the light-shielding film 19. Steps 1S are formed at the boundaries of these regions. In the present embodiment, the steps 1S are classified into the following three types: a step caused by a level difference between the insulating layer 13C as the outermost surface in an opening 18X and the second electrode 18; a step caused by a level difference between the second electrode 18 and the light-shielding film 19; and a step caused by a level difference between the insulating layer 13C and the light-shielding film 19.

The steps have a height greater than the thickness of the alignment film, for example.

Use of a substrate with such steps having a height greater than the thickness of the alignment film is more likely to cause light leakage and a decrease in contrast ratio. However, the liquid crystal display device of the present embodiment can reduce or prevent light leakage and a decrease in contrast ratio even when including a substrate with such great steps.

The steps have a height of 200 nm or greater and 1000 nm or less, for example.

As described above, the steps of the substrate are formed due to the openings of the second electrode in the FFS mode. With the height of the steps set to 200 nm or greater, the light-shielding film can be made thick to further reduce or prevent color mixing in oblique views. The electrodes can also be made thick to further reduce their resistance, allowing for application of a stronger electric field. The height of the steps is more preferably 250 nm or greater, still more preferably 300 nm or greater. Conversely, excessive thickness of the light-shielding film and electrodes can lead to saturation of the aforementioned effects. Thus, the steps preferably have a height of 1000 nm or less, more preferably 950 nm or less, still more preferably 900 nm or less. Even with the steps having a height falling within the above range, the present embodiment can reduce or prevent light leakage and a decrease in contrast ratio.

The alignment film includes a base layer arranged adjacent to the one of the pair of substrates and a liquid crystal alignment layer arranged adjacent to the liquid crystal layer. The base layer and the liquid crystal alignment layer each have a structure derived from a polymer having a crosslinkable functional group.

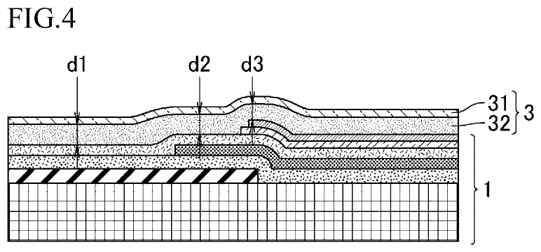

The present inventors examined the cause of light leakage and a decrease in contrast ratio when a conventional alignment film is stacked on a substrate having steps as shown in FIGS. 1 and 2 in a liquid crystal display device. As a result, they found that these issues were caused by regions where the alignment film was overly thin on and around the tops of steps. FIG. 3 is a cross-sectional view schematically showing a liquid crystal display device in which a conventional alignment film is formed on a substrate having steps, with a focus on the alignment film and its vicinity. FIG. 4 is a cross-sectional view schematically showing the liquid crystal display device of the present embodiment, with a focus on an alignment film and its vicinity. In FIGS. 3 and 4, unlike in FIG. 2, there is a region where the first electrode is absent in an opening, and a step is formed also in the boundary between a region with the first electrode and a region without the first electrode. The color filters, planarization layer, and underlying layers are shown in a simplified form. When a conventional alignment film 2 is formed on the surface of the substrate 1, which has steps as shown in FIG. 3, the conventional alignment film 2 on and around the tops of the steps flows down to the lower areas over time. As a result, thicknesses d2 and d3 of the conventional alignment film 2 on the steps of the substrate 1 become smaller than a thickness d1 of the conventional alignment film 2 on the portion of the substrate 1 without the steps. As the thickness of the conventional alignment film 2 reduces, the alignment azimuth of the liquid crystal molecules deviates from the intended direction, which results in light leakage and a decrease in contrast ratio during black display. In particular, the thickness decreases more significantly on higher steps and at points closer to the steps. The thickness d3 at the highest point of the step is extremely small, which significantly contributes to the decrease in contrast ratio.

In contrast, as shown in FIG. 4, an alignment film 3 in the present embodiment includes two layers, namely a base layer 32 and a liquid crystal alignment layer 31, and the base layer 32 and the liquid crystal alignment layer 31 each have a structure derived from a polymer having a crosslinkable functional group. The crosslinkable functional group is crosslinked by the later-described crosslinking material. The crosslinking makes the alignment film 3 in the present embodiment less likely to flow down from the applied position. This enables the thickness of the alignment film 3 in the present embodiment to be retained within a certain range even when the substrate 1 has steps. As a result, the light leakage and the decrease in contrast ratio can be reduced or prevented even when the substrate has steps.

The light leakage and the decrease in contrast ratio can possibly be resolved by increasing the viscosity of the alignment film formed on or around the tops of the steps to make the alignment film less likely to flow down to the lower areas. However, simply increasing the viscosity of the alignment film introduces another issue that it becomes difficult to form the alignment film with a uniform thickness. Nevertheless, since the alignment film in the present embodiment is made less likely to flow down due to crosslinking, a polymer having a crosslinkable functional group does not need to have an extremely high viscosity. Thus, a polymer having a crosslinkable functional group can be applied with a uniform thickness to form the alignment film.

The crosslinkable functional group contained in the polymer having a crosslinkable functional group may be any crosslinkable functional group that can be crosslinked by a crosslinking material, and may be, for example, an epoxy group or an isocyanate group. In particular, the crosslinkable functional group is preferably an epoxy group for its high heat stability and sufficient reactivity.

Examples of the polymer having a crosslinkable functional group include polyimide-based polymers, polyamic acid-based polymers, polyamide-based polymers, polymaleimide-based polymers, poly(meth)acrylic acid-based polymers, polysiloxane-based polymers, polysilsesquioxane-based polymers, polyphosphazene-based polymers, and copolymers of any of these polymers.

The liquid crystal alignment layer preferably has undergone alignment treatment. The alignment treatment method is not limited and may be a rubbing method or a photoalignment method, for example. In particular, to further increase the contrast ratio, the liquid crystal alignment layer is preferably a photoalignment film that exhibits the ability of aligning liquid crystal molecules upon photoirradiation, i.e., a photoalignment film that has undergone photoalignment treatment.

Examples of the material of the photoalignment film include polymers having a photoreactive functional group. Specific examples of the photoreactive functional group include azobenzene, chalcone, cinnamate, coumarin, tolane, and stilbene groups. The liquid crystal alignment layer may be a vertical alignment layer or a horizontal alignment layer.

The liquid crystal alignment layer preferably has a structure derived from a polyimide-based, polyamic acid-based, polysiloxane-based, polyacrylic acid-based, or polymethacrylic acid-based polymer that has an epoxy group in a side chain. With the liquid crystal alignment layer having a structure derived from such a polymer, the thickness of the alignment film can be made more uniform and the light leakage and the decrease in contrast ratio can be further reduced or prevented. In particular, to further reduce or prevent the light leakage and the decrease in contrast ratio, preferably, the liquid crystal alignment layer has a structure derived from a polyimide-based or polyamic acid-based horizontal alignment polymer represented by the following structural formula (2) or (3), a structure derived from a polyimide-based or polyamic acid-based vertical alignment polymer represented by the following structural formula (2′) or (3′), a structure derived from a polysiloxane-based vertical alignment polymer represented by the following structural formula (4) or (5), or a structure derived from a polyacrylic acid-based or polymethacrylic acid-based vertical alignment polymer represented by the following structural formula (6).

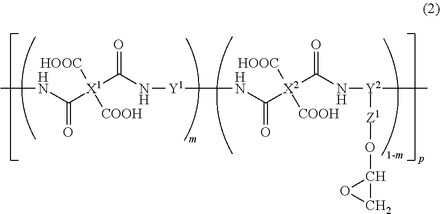

Here, X¹ and X² each independently represent any one of the following structural formulas (X-a1) to (X-a13) and (X-b1) to (X-b4). Y¹ represents any one of the following structural formulas (Y-a1) to (Y-a14) and (Y-b1) to (Y-b8). Y² represents any one of (Y-c1) to (Y-c16) and (Y-d1) to (Y-d8). Z¹ represents a direct bond with an epoxy group or a linear or branched alkylene group having 1 or more and 12 or less carbon atoms. m represents a value of 0 or greater and 0.5 or less. p represents an integer of 1 or greater.

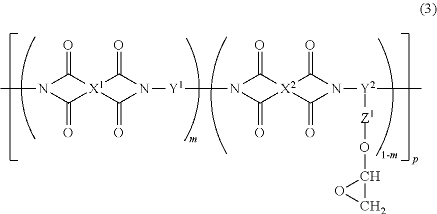

Here, X¹ and X² each independently represent any one of the following structural formulas (X-a1) to (X-a13) and (X-b1) to (X-b4). Y¹ represents any one of the following structural formulas (Y-a1) to (Y-a14) and (Y-b1) to (Y-b8). Y² represents any one of (Y-c1) to (Y-c16) and (Y-d1) to (Y-d8). Z¹ represents a direct bond with an epoxy group or a linear or branched alkylene group having 1 or more and 12 or less carbon atoms. m represents a value of 0 or greater and 0.5 or less. p represents an integer of 1 or greater.

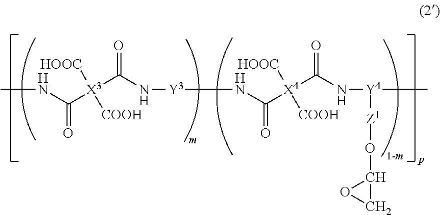

Here, X³ and X⁴ each independently represent any one of the following structural formulas (X-a1) to (X-a13) and (X-b1) to (X-b4). Y³ represents a moiety in which a side chain represented by any one of the following structural formulas (Za-1) to (Z-a21) is bonded to any one of the following structural formulas (Y-c1) to (Y-c16) and (Y-d1) to (Y-d8). Y⁴ represents any one of the following structural formulas (Y-c1) to (Y-c16) and (Y-d1) to (Y-d8). Z² represents a direct bond with an epoxy group or a linear or branched alkylene group having 1 or more and 12 or less carbon atoms. m represents a value of 0 or greater and 0.5 or less. p represents an integer of 1 or greater.

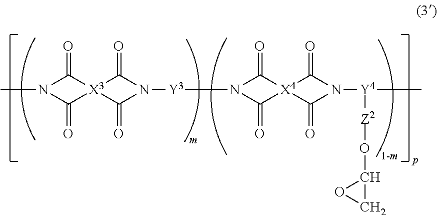

Here, X³ and X⁴ each independently represent any one of the following structural formulas (X-a1) to (X-a13) and (X-b1) to (X-b4). Y³ represents a moiety in which a side chain represented by any one of (Z-a1) to (Z-a21) is bonded to any one of the following structural formulas (Y-c1) to (Y-c16) and (Y-d1) to (Y-d8). Y⁴ represents any one of the following structural formulas (Y-c1) to (Y-c16) and (Y-d1) to (Y-d8). Z² represents a direct bond with an epoxy group or a linear or branched alkylene group having 1 or more and 12 or less carbon atoms. m represents a value of 0 or greater and 0.5 or less. p represents an integer of 1 or greater.

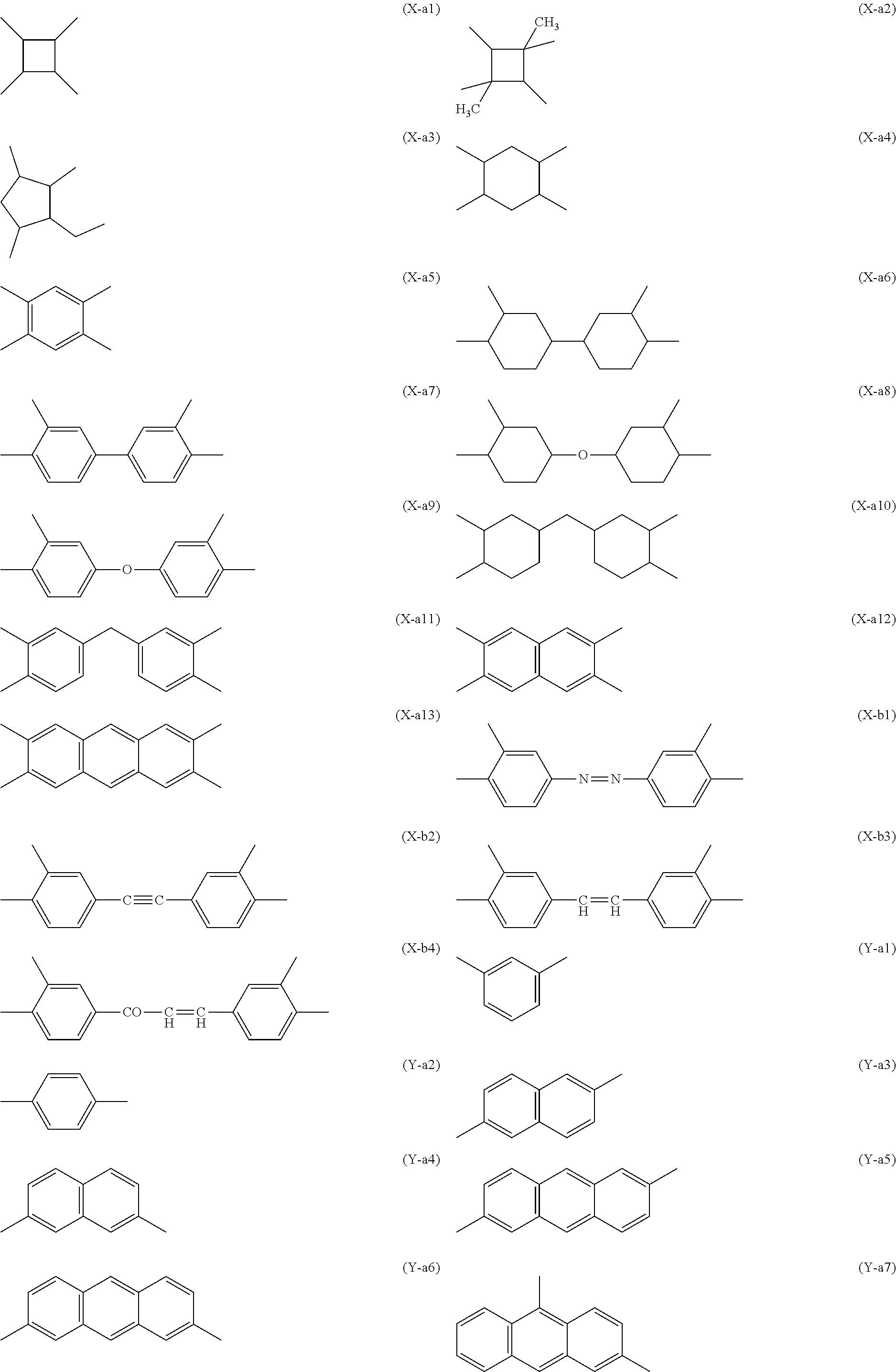

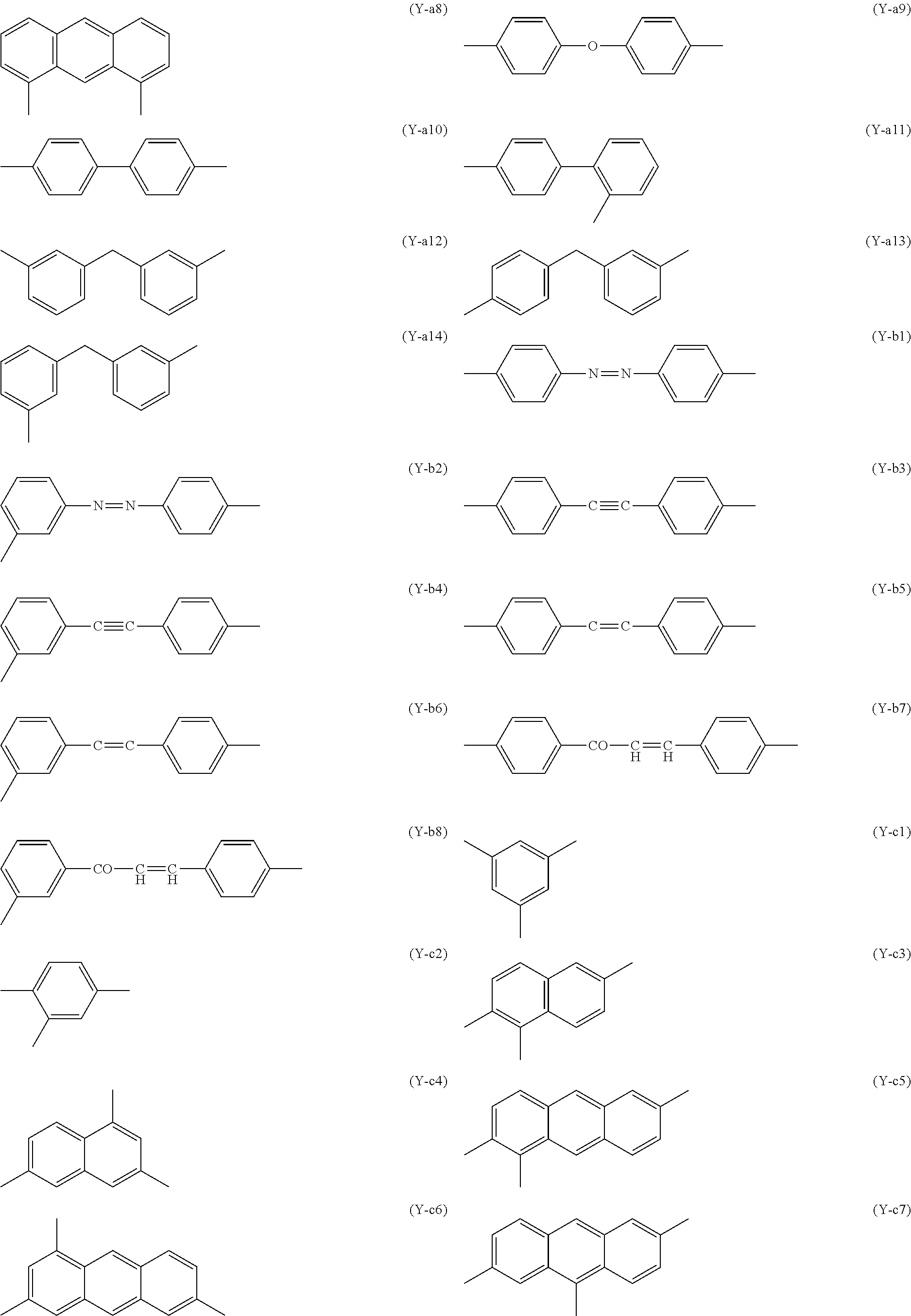

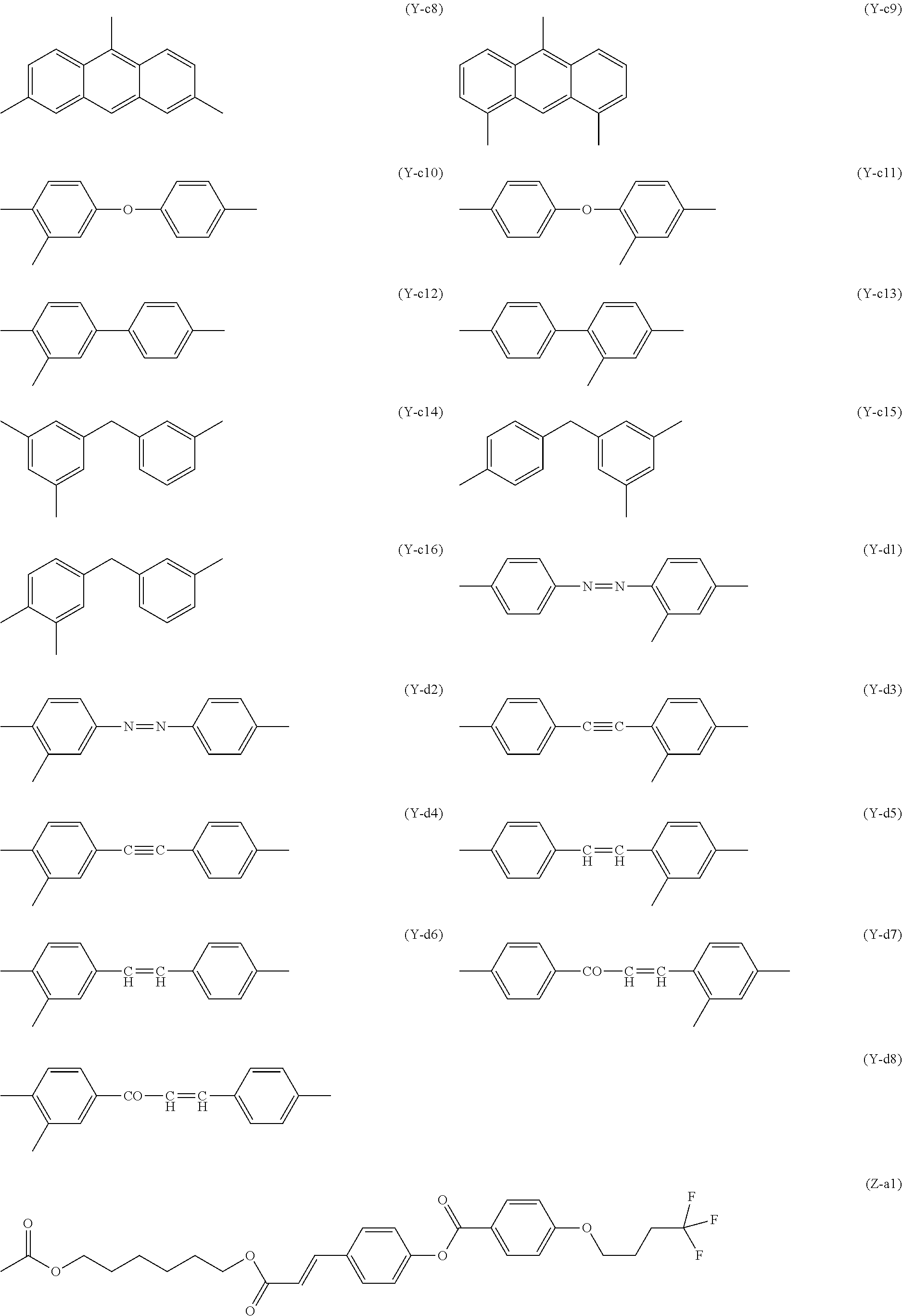

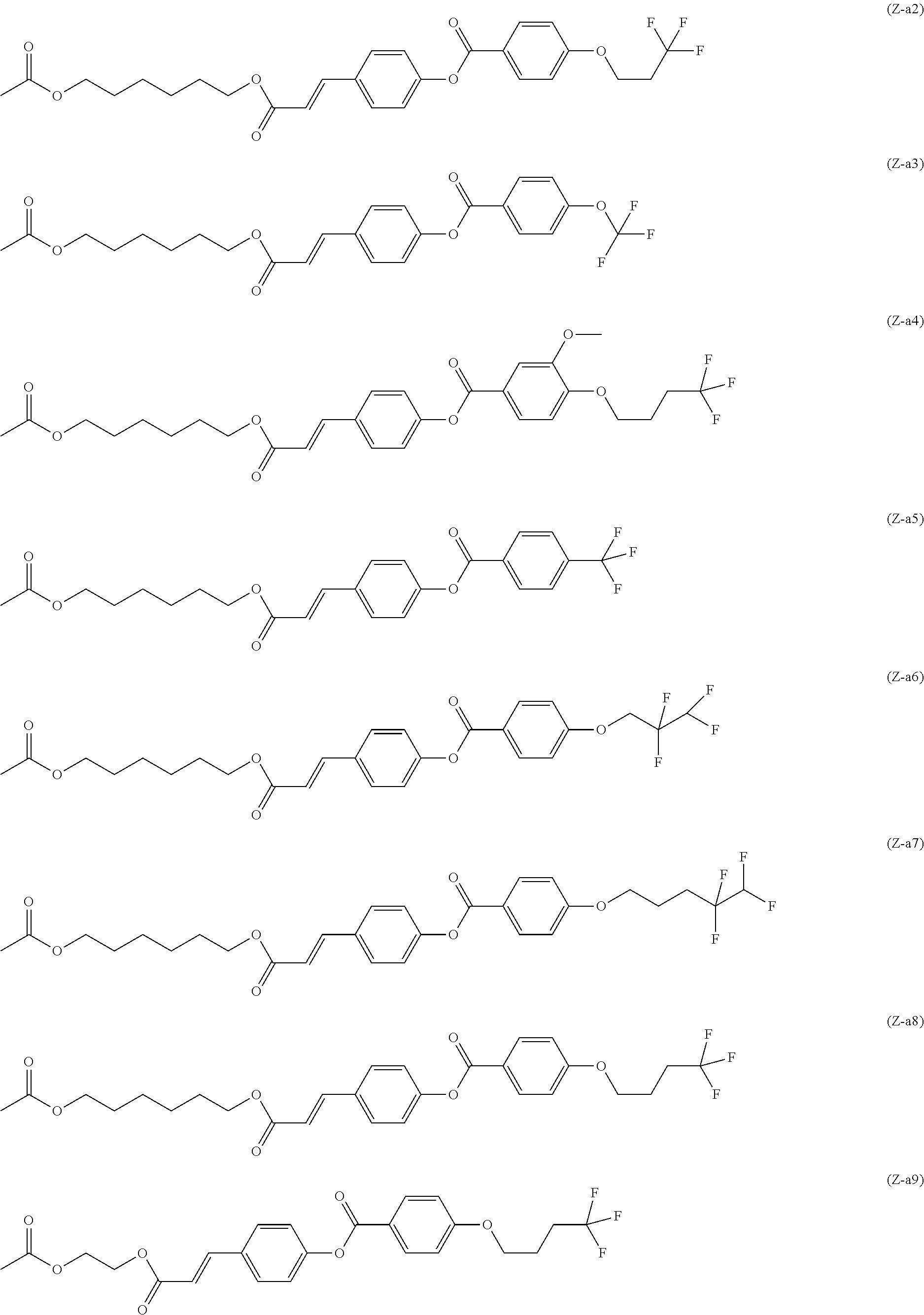

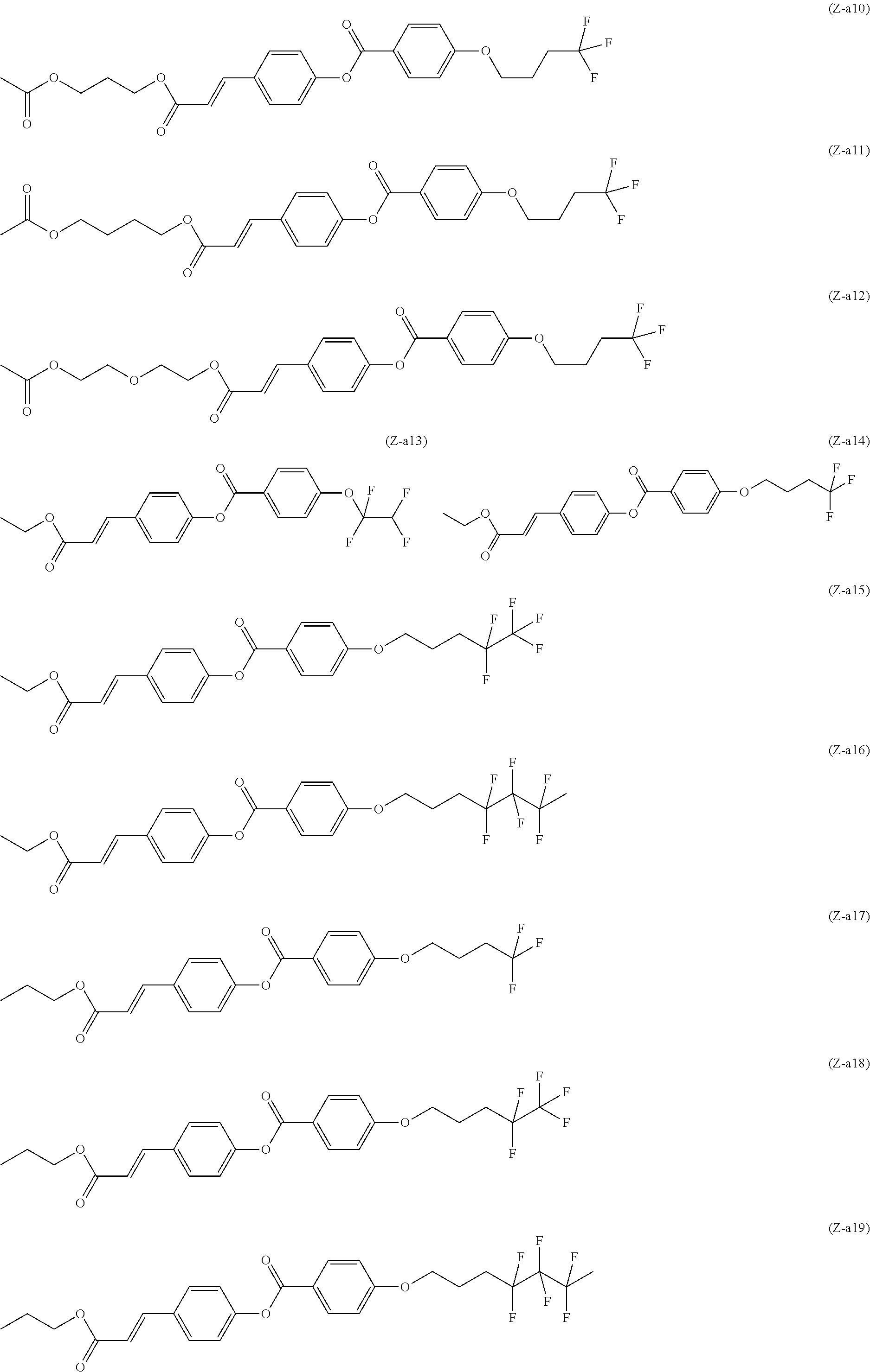

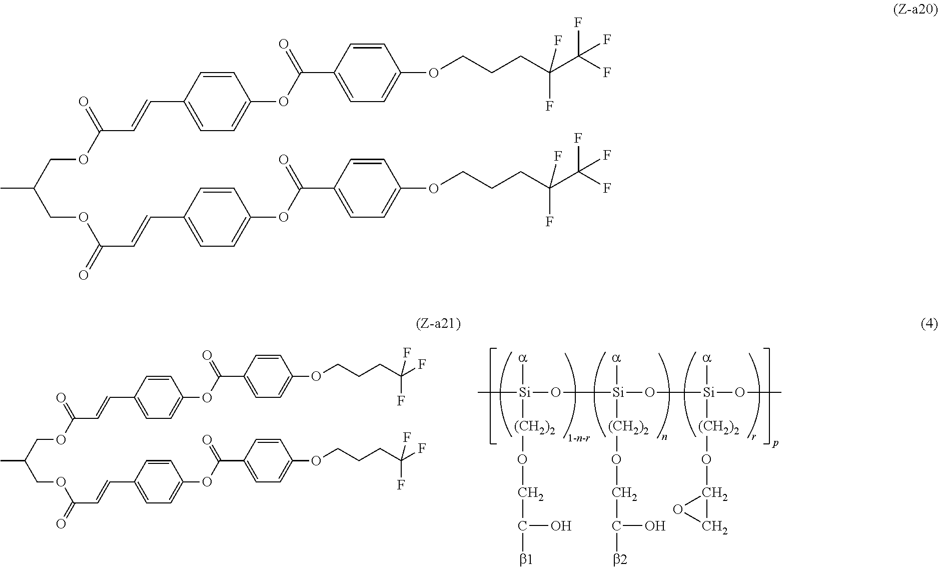

Here, a's each independently represent a hydrogen atom, a methyl group, or a methoxy group. β¹ and β² each independently represent the following structural formula (β-1) or (β-2). n represents a value of 0 or greater and 0.3 or less. r represents a value of greater than 0 and 0.6 or less. p represents an integer of 1 or greater.

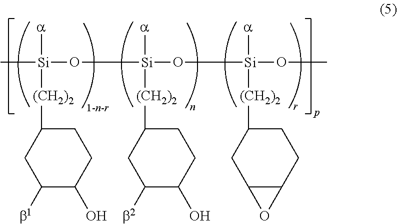

Here, a's each independently represent a hydrogen atom, a methyl group, or a methoxy group. β¹ and β² each independently represent the following structural formula (β-1) or (β-2). n represents a value of 0 or greater and 0.3 or less. r represents a value of greater than 0 and 0.6 or less. p represents an integer of 1 or greater.

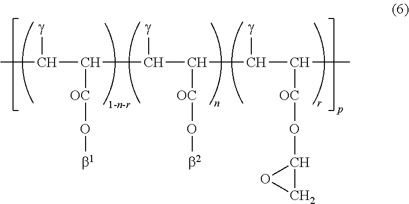

Here, γ's each independently represent a hydrogen atom or a methyl group. β¹ and β² each independently represent the following structural formula (β-1) or (β-2). n represents a value of 0 or greater and 0.3 or less. r represents a value of greater than 0 and 0.6 or less. p represents an integer of 1 or greater.

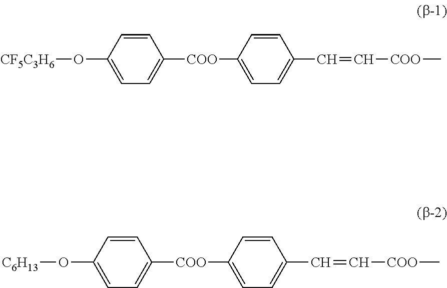

In the structural formulas (4), (5), and (6), r is more preferably 0.2 or greater and 0.5 or less. With r in these structural formulas falling within this range, the light leakage and the decrease in contrast ratio can be further reduced or prevented.

The weight average molecular weight of the polymer having a crosslinkable functional group, which serves as the raw material of the liquid crystal alignment layer, should be such that it provides a viscosity sufficient to prevent the layer from easily flowing down to the lower areas of steps upon application to achieve a uniform thickness. For example, the weight average molecular weight is preferably 10000 or more, more preferably 30000 or more, while preferably 1000000 or less, more preferably 500000 or less.

The base layer may be any layer that has a structure derived from a polymer having a crosslinkable functional group. The base layer preferably has a structure derived from a polyimide-based or polyamic acid-based polymer represented by any one of the following structural formulas (7), (8), (7′), and (8′) for their ability of forming a film that has high heat stability and high electrical insulation.

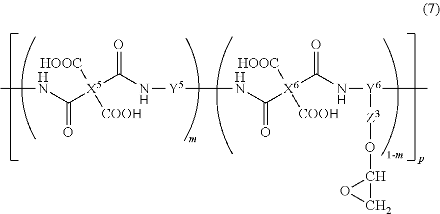

Here, X⁵ and X⁶ each independently represent any one of the structural formulas (X-c1) to (X-c11). Y⁵ represents any one of the structural formulas (Y-a1) to (Y-a14). Y⁶ represents any one of the structural formulas (Y-c1) to (Y-c16). Z³ represents a direct bond with an epoxy group or a linear or branched alkylene group having 1 or more and 12 or less carbon atoms. m represents a value of 0 or greater and 0.5 or less. p represents an integer of 1 or greater.

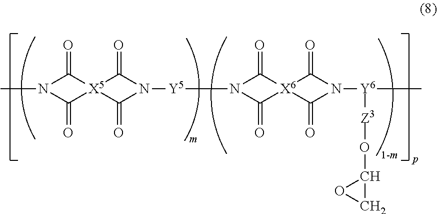

Here, X³ and X⁶ each independently represent any one of the structural formulas (X-c1) to (X-c11). Y⁵ represents any one of the structural formulas (Y-a1) to (Y-a14). Y⁶ represents any one of the structural formulas (Y-c1) to (Y-c16). Z³ represents a direct bond with an epoxy group or a linear or branched alkylene group having 1 or more and 12 or less carbon atoms. m represents a value of 0 or greater and 0.5 or less. p represents an integer of 1 or greater.

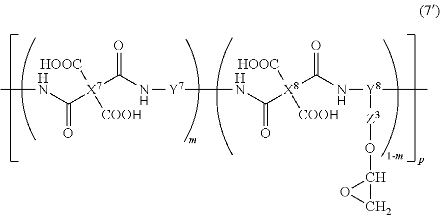

Here, X⁷ and X⁸ each independently represent any one of the following structural formulas (X-c1) to (X-c11). Y⁷ represents a moiety in which a side chain represented by any one of the following structural formulas (Z-b1) to (Z-b7) is bonded to any one of the structural formulas (Y-c1) to (Y-c16). Y⁸ represents any one of the structural formulas (Y-c1) to (Y-c16). Z⁴ represents a direct bond with an epoxy group or a linear or branched alkylene group having 1 or more and 12 or less carbon atoms. m represents a value of 0 or greater and 0.5 or less. p represents an integer of 1 or greater.

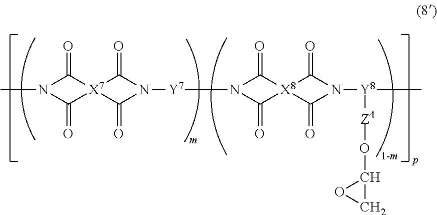

Here, X⁷ and X⁸ each independently represent any one of the following structural formulas (X-c1) to (X-c11). Y⁷ represents a moiety in which a side chain represented by any one of (Z-b1) to (Z-b7) is bonded to any one of the structural formulas (Y-c1) to (Y-c16). Y⁸ represents any one of the structural formulas (Y-c1) to (Y-c16). Z⁴ represents a direct bond with an epoxy group or a linear or branched alkylene group having 1 or more and 12 or less carbon atoms. m represents a value of 0 or greater and 0.5 or less. p represents an integer of 1 or greater.

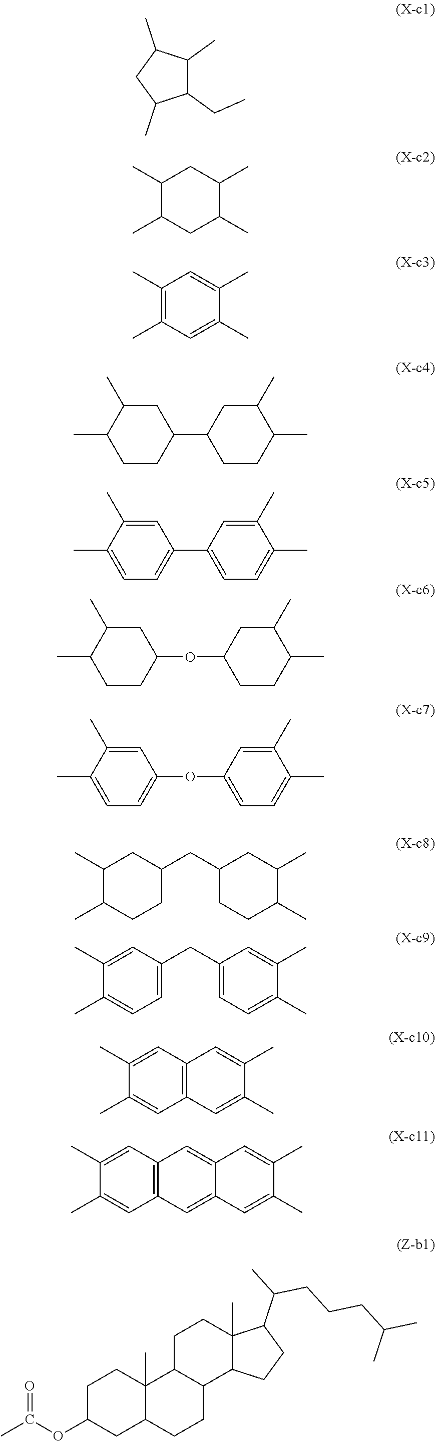

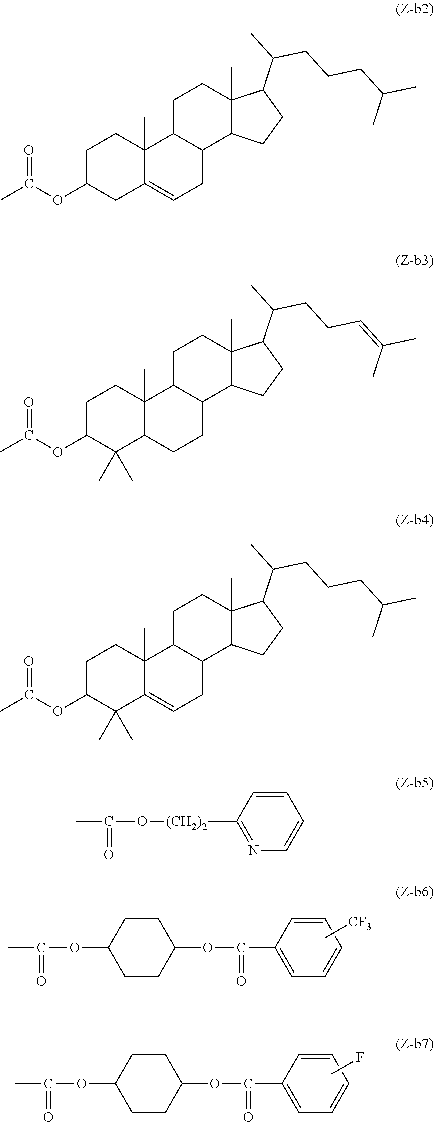

The weight average molecular weight of the polymer having a crosslinkable functional group, which serves as the raw material of the base layer, should be such that it provides a viscosity sufficient to prevent the layer from easily flowing down to the lower areas of steps upon application to achieve a uniform thickness. For example, the weight average molecular weight is preferably 10000 or more, more preferably 30000 or more, while preferably 1000000 or less, more preferably 500000 or less.

Preferably, the base layer and the liquid crystal alignment layer each include 20% by weight or more and 80% by weight or less of a structure derived from the polymer having a crosslinkable functional group.

With the percentage of the structure derived from the polymer having a crosslinkable functional group in each of the base layer and the liquid crystal alignment layer set to fall within the above range, the effect of crosslinking by the later-described crosslinking material is further enhanced, which leads to further reduction or prevention of the light leakage and the decrease in contrast ratio. The percentage of the structure derived from the polymer having a crosslinkable functional group in each of the base layer and the liquid crystal alignment layer is more preferably 25% by weight or more and 75% by weight or less.

The base layer and the liquid crystal alignment layer each have a structure derived from a crosslinking material represented by the following structural formula (1).

When the crosslinkable functional group of the polymer, which serves as the raw material of each of the base layer and the liquid crystal alignment layer, is crosslinked by the crosslinking material represented by the following structural formula (1), the alignment film formed on and around the tops of the steps can be made less likely to flow down to the lower areas, so that the thickness of the alignment film can be maintained within a certain range. Also, since the alignment film becomes less likely to flow down only after the crosslinking and the polymer having a crosslinkable functional group itself does not need to have a very high viscosity, the polymer can be applied with a uniform thickness.

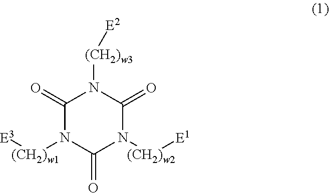

Here, E¹, E², and E³ each independently represent an amino, methyl amino, or hydroxy group. w¹, w², and w³ each independently represent an integer of 1 or greater and 18 or less.

Preferably, E¹, E², and E³ in the structural formula (1) each independently represent an amino or methyl amino group.

With E¹ to E³ being any of the functional groups, the heat reactivity further increases and the voltage holding ratio can be further increased.

Preferably, w1, w2, and w3 in the structural formula (1) each independently represent an integer of 4 or greater and 18 or less.

In particular, when E¹ to E³ are each an amino or methyl amino group, there is an advantage that the heat reactivity is higher and the voltage holding ratio is even higher than when they are hydroxy groups. However, if unreacted amino or methyl amino groups remain and react during use of the liquid crystal display device, they may cause an alignment change such as a pre-tilt angle change due to their high heat reactivity. When w1 to w3 are each an integer falling within the above range, i.e., when each alkyl chain is longer, the amino or methyl amino group bonded to the end of the alkyl chain is more likely to react, making unreacted amino or methyl amino groups less likely to remain. As a result, the voltage holding ratio can be further increased while alignment changes due to unreacted amino or methyl amino groups are reduced or prevented. More preferably, w1, w2, and w3 are each independently 12 or less.

Preferably, the percentage by weight of the structure derived from the crosslinking material in the total of the structures derived from the respective polymers constituting the base layer and the liquid crystal alignment layer is 20% or more and 80% or less.

When the percentage by weight of the structure derived from the crosslinking material in the total of the structures derived from the respective polymers constituting the base layer and the liquid crystal alignment layer falls within the above range, the crosslinking material can sufficiently crosslink the polymers constituting the base layer and the liquid crystal alignment layer, making the liquid crystal alignment layer and the base layer even less likely to flow down to the lower areas of the steps. The percentage by weight of the structure derived from the crosslinking material in the total of the structures derived from the respective polymers constituting the base layer and the liquid crystal alignment layer is more preferably 25% or more, still more preferably 30% or more, while more preferably 75% or less, still more preferably 70% or less.

### EXAMPLES

Hereinbelow, the present invention is described in more detail with reference to examples and comparative examples. The present invention is not limited to these examples.

### Example 1

### (1) Preparation of Liquid Crystal Alignment Layer, Base Layer, and Crosslinking Material

A polymer having a crosslinkable functional group as the material of a liquid crystal alignment layer was a polyamic acid-based horizontal alignment polymer that had a structure represented by the structural formula (3), wherein X¹ and X² were X-a1, Y¹ was Y-a9, Y² was Y-c11, Z¹ was a direct bond with an epoxy group, and m was 0.5, and that had a weight average molecular weight of about 50000. A polymer having a crosslinkable functional group as the material of a base layer was a polyimide-based polymer that had a structure represented by the structural formula (7), wherein X⁵ and X⁶ were X-c1, Y⁵ was Y-a9, Y⁶ was Y-c11, Z³ was a direct bond with an epoxy group, and m was 0.5, and that had a weight average molecular weight of about 50000.

Additionally, a crosslinking material was a compound that had a structure represented by the structural formula (1), wherein w¹ to w³ were each 6 and E¹ to E³ were each an amino group.

### (2) Production of Liquid Crystal Display Device

A substrate was prepared that included pixel electrodes, a common electrode, color filters, and a light-shielding film to prevent color mixing caused by the color filters, as shown in FIGS. 1 and 2. The substrate had 250-nm steps and a resolution of 1400 ppi. First, the surface of the substrate with the steps was coated with a mixture of a polymer having a crosslinkable functional group as the material of the base layer, a polymer having a crosslinkable functional group as the material of the liquid crystal alignment layer, and the crosslinking material to a thickness of 300 nm. The weight ratio of the polymer having a crosslinkable functional group as the material of the liquid crystal alignment layer to the polymer having a crosslinkable functional group as the material of the base layer was 1:1 upon coating. The crosslinking material content (in percentage by weight) in the total weight of the polymer having a crosslinkable functional group as the material of the liquid crystal alignment layer and the polymer having a crosslinkable functional group as the material of the base layer was 20%. Then, the workpiece was baked at 230° C. for 40 minutes to form the liquid crystal alignment layer and the base layer by causing phase separation while crosslinking the polymer having a crosslinkable functional group as the material of the liquid crystal alignment layer and the polymer having a crosslinkable functional group as the material of the base layer using the crosslinking material. After the baking, the liquid crystal alignment layer was irradiated with polarized UV (peak wavelength: 250 nm) at 500 mJ/cm² for photoalignment treatment. Thereafter, a positive liquid crystal was dropped onto the liquid crystal alignment layer by a liquid crystal dropping process (one drop filling: ODF), and the substrate was bonded with a counter substrate to obtain an FFS mode liquid crystal display device. The obtained liquid crystal display device was measured for the minimum film thickness of the alignment film on the step portions using an electron microscope, which resulted in 10 nm.

### (3) Measurement of Luminance

The obtained liquid crystal display device was measured for the luminance before a driving test, using a luminance meter (SR-5000 available from TechnoOptis Co., Ltd.). Subsequently, the liquid crystal display device was driven for 1000 hours and then measured for the luminance after the driving test by the same procedure. Table 1 shows the results.

### (4) Measurement of Contrast Ratio

The obtained liquid crystal display device was measured for the luminance during bright display and the luminance during dark display using the luminance meter (SR-5000 available from TechnoOptis Co., Ltd.). Based on the ratio of the two luminance values obtained, the contrast ratio before the driving test was calculated. Subsequently, the liquid crystal display device was driven for 1000 hours, and then the contrast ratio after the driving test was calculated by the same procedure. Table 1 shows the results.

### Examples 2 to 4, Comparative Example 1

Liquid crystal display devices were produced and the luminance and the contrast ratio were determined as in Example 1, except that the crosslinking material content (in percentage by weight) was changed to 0%, 40%, 60%, and 80%. Table 1 shows the results.

TABLE 1

| | Crosslinking | Minimum film | | | | |
|---|---|---|---|---|---|---|
| | material content | thickness on step | Before driving test | | After driving test | |
| | (%) | portions (nm) | Luminance (%) | Contrast ratio | Luminance (%) | Contrast ratio |
| Comparative | 0 | 3 | 100 | 350 | 99.5 | 300 |
| Example 1 | | | | | | |
| Example 1 | 20 | 10 | 100 | 550 | 99.5 | 550 |
| Example 2 | 40 | 15 | 100 | 550 | 99.5 | 550 |
| Example 3 | 60 | 20 | 100 | 520 | 99.2 | 520 |
| Example 4 | 80 | 20 | 100 | 440 | 97.5 | 420 |

### Example 5

### (1) Preparation of Liquid Crystal Alignment Layer, Base Layer, and Crosslinking Material

A polymer having a crosslinkable functional group as the material of the liquid crystal alignment layer was a polyamic acid-based horizontal alignment polymer that had a structure represented by the structural formula (3′), wherein X³ and X⁴ were X-a3, Y³ was Y-b1, Y⁴ was Y-d1, Z² was a direct bond with an epoxy group, and m was 0.5, and that had a weight average molecular weight of about 50000. A polymer having a crosslinkable functional group as the material of the base layer was a polyimide-based polymer that had a structure represented by the structural formula (7), wherein X⁵ and X⁶ were X-c1, Y⁵ was Y-a9, Y⁶ was Y-c11, Z³ was a direct bond with an epoxy group, and m was 0.5, and that had a weight average molecular weight of about 50000.

Additionally, a crosslinking material was a compound that had a structure represented by the structural formula (1), wherein w1 to w3 were each 6 and E¹ to E³ were each a hydroxy group.

### (2) Production of Liquid Crystal Display Device and Measurement of Luminance and Contrast Ratio

A liquid crystal display device was obtained as in Example 1, except that the above polymer having a crosslinkable functional group as the material of the liquid crystal alignment layer, the above polymer having a crosslinkable functional group as the material of the base layer, and the above crosslinking material were used, and the luminance and the contrast ratio were measured by the same procedure as in Example 1. Table 2 shows the results.

### Examples 6 to 8, Comparative Example 2

Liquid crystal display devices were produced and the luminance and the contrast ratio were measured as in Example 5, except that the crosslinking material content (in percentage by weight) was changed to 0%, 40%, 60%, and 80%. Table 2 shows the results.

TABLE 2

| | Crosslinking | Minimum film | | | | |
|---|---|---|---|---|---|---|
| | material content | thickness on step | Before driving test | | After driving test | |
| | (%) | portions (nm) | Luminance (%) | Contrast ratio | Luminance (%) | Contrast ratio |
| Comparative | 0 | 3 | 100 | 450 | 96.5 | 420 |
| Example 2 | | | | | | |
| Example 5 | 20 | 30 | 100 | 750 | 98.7 | 750 |
| Example 6 | 40 | 40 | 100 | 750 | 98.7 | 750 |
| Example 7 | 60 | 50 | 100 | 710 | 98.3 | 680 |
| Example 8 | 80 | 50 | 100 | 510 | 96.5 | 440 |

### Example 9

### (1) Preparation of Liquid Crystal Alignment Layer, Base Layer, and Crosslinking Material

A polymer having a crosslinkable functional group as the material of the liquid crystal alignment layer was a polysiloxane-based vertical alignment polymer that had a structure represented by the structural formula (4), wherein α's were each a methoxy group, β¹ was β-1, β² was β-2, n was 0.25, and r was 0.5, and that had a weight average molecular weight of about 50000. A polymer having a crosslinkable functional group as the material of the base layer was a polyimide-based polymer that had a structure represented by the structural formula (7), wherein X⁵ and X⁶ were X-c1, Y⁵ was Y-a9, Y⁶ was Y-c11, Z³ was a direct bond with an epoxy group, and m was 0.5, and that had a weight average molecular weight of about 50000.

Additionally, a crosslinking material was a compound that had a structure represented by the structural formula (1), wherein w¹ to w³ were each 6 and E¹ to E³ were each a hydroxy group.

### (2) Production of Liquid Crystal Display Device and Measurement of Luminance and Contrast Ratio

A liquid crystal display device was obtained as in Example 1, except that the above polymer having a crosslinkable functional group as the material of the liquid crystal alignment layer, the above polymer having a crosslinkable functional group as the material of the base layer, and the above crosslinking material were used, and the luminance and the contrast ratio were measured as in Example 1. Table 3 shows the results.

### Examples 10 and 11, Comparative Example 3

Liquid crystal display devices were produced and the luminance and the contrast ratio were measured as in Example 9, except that the crosslinking material content (in percentage by weight) was changed to 0%, 40%, and 60%. Table 3 shows the results.

TABLE 3

| | Crosslinking | Minimum film | | | | |
|---|---|---|---|---|---|---|
| | material content | thickness on step | Before driving test | | After driving test | |
| | (%) | portions (nm) | Luminance (%) | Contrast ratio | Luminance (%) | Contrast ratio |
| Comparative | 0 | 3 | 100 | 1800 | 94.5 | 2700 |
| Example 3 | | | | | | |
| Example 9 | 20 | 30 | 100 | 3300 | 98.3 | 3100 |
| Example 10 | 40 | 40 | 100 | 3500 | 98.8 | 3200 |
| Example 11 | 60 | 40 | 100 | 3300 | 98.7 | 3200 |

What is claimed is:

1. A liquid crystal display device comprising:
a pair of substrates;
a liquid crystal layer held between the pair of substrates; and
an alignment film arranged between one of the pair of substrates and the liquid crystal layer,
the one of the pair of substrates including a step on a surface that is in contact with the alignment film,
the alignment film including a base layer arranged adjacent to the one of the pair of substrates and a liquid crystal alignment layer arranged adjacent to the liquid crystal layer,
the base layer and the liquid crystal alignment layer each having a structure derived from a polymer having a crosslinkable functional group,
the base layer and the liquid crystal alignment layer each having a structure derived from a crosslinking material represented by the following structural formula (1): 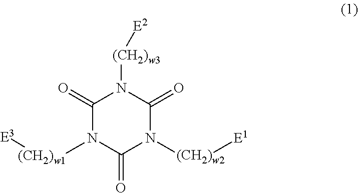
wherein E¹, E², and E³ each independently represent an amino, methyl amino, or hydroxy group, and w¹, w², and w³ each independently represent an integer of 1 or greater and 18 or less.

2. The liquid crystal display device according to claim 1,
wherein w¹, w², and w³ in the structural formula (1) each independently represent an integer of 4 or greater and 18 or less.

3. The liquid crystal display device according to claim 1,
wherein E¹, E², and E³ in the structural formula (1) each independently represent an amino or methyl amino group.

4. The liquid crystal display device according to claim 1,
wherein a percentage by weight of the structure derived from a crosslinking material in a total of the structures derived from the respective polymers constituting the base layer and the liquid crystal alignment layer is 20% or more and 80% or less.

5. The liquid crystal display device according to claim 1,
wherein the step has a height greater than a thickness of the alignment film.

6. The liquid crystal display device according to claim 1,
wherein the step has a height of 200 nm or greater and 1000 nm or less.

7. The liquid crystal display device according to claim 1,
wherein the liquid crystal alignment layer is a photoalignment film that has undergone photoalignment treatment.

8. The liquid crystal display device according to claim 1,
wherein the liquid crystal alignment layer has a structure derived from a polyimide-based, polyamic acid-based, polysiloxane-based, polyacrylic acid-based, or polymethacrylic acid-based polymer that has an epoxy group in a side chain.

9. The liquid crystal display device according to claim 8,
wherein the liquid crystal alignment layer has a structure derived from a polyimide-based or polyamic acid-based horizontal alignment polymer represented by the following structural formula (2) or (3): 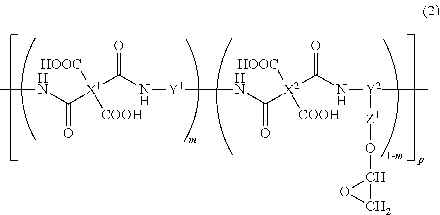
wherein X¹ and X² each independently represent any one of the following structural formulas (X-a1) to (X-a13) and (X-b1) to (X-b4), Y¹ represents any one of the following structural formulas (Y-a1) to (Y-a14) and (Y-b1) to (Y-b8), Y² represents any one of the following structural formulas (Y-c1) to (Y-c16) and (Y-d1) to (Y-d8), Z¹ represents a direct bond with an epoxy group or a linear or branched alkylene group having 1 or more and 12 or less carbon atoms, m represents a value of 0 or greater and 0.5 or less, and p represents an integer of 1 or greater, 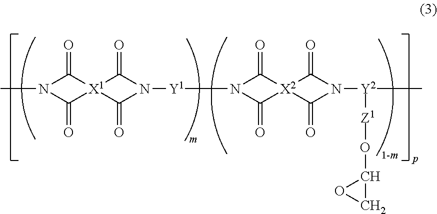
wherein X¹ and X² each independently represent any one of the following structural formulas (X-a1) to (X-a13) and (X-b1) to (X-b4), Y¹ represents any one of the following structural formulas (Y-a1) to (Y-a14) and (Y-b1) to (Y-b8), Y² represents any one of the following structural formulas (Y-c1) to (Y-c16) and (Y-d1) to (Y-d8), Z¹ represents a direct bond with an epoxy group or a linear or branched alkylene group having 1 or more and 12 or less carbon atoms, m represents a value of 0 or greater and 0.5 or less, and p represents an integer of 1 or greater,

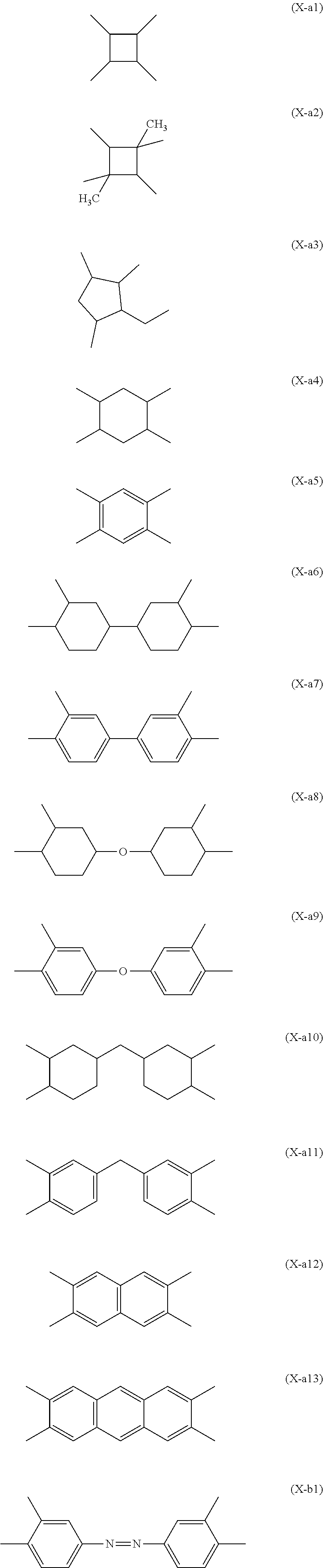

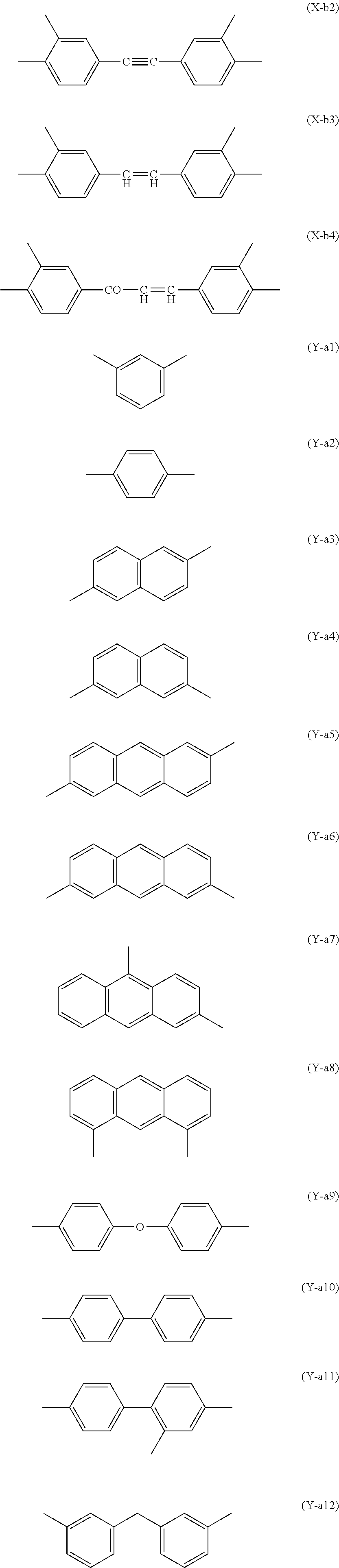

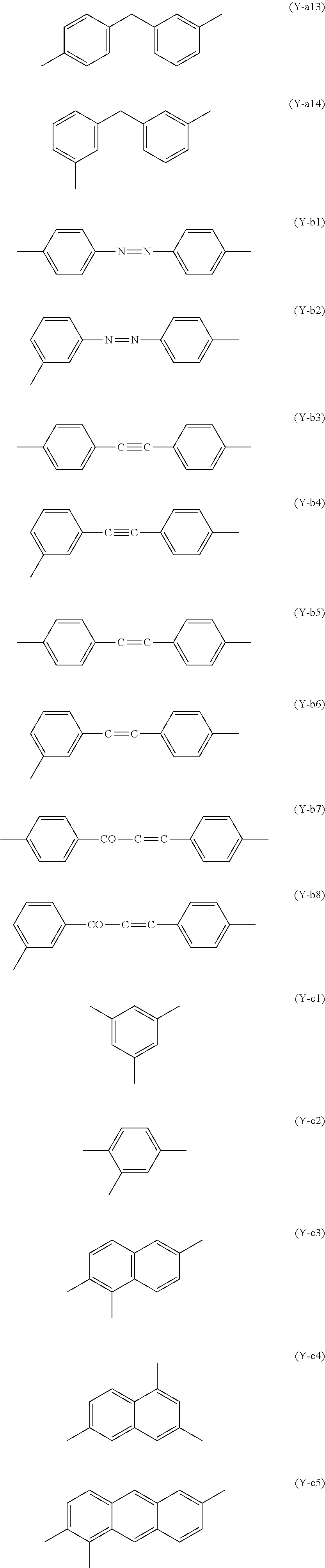

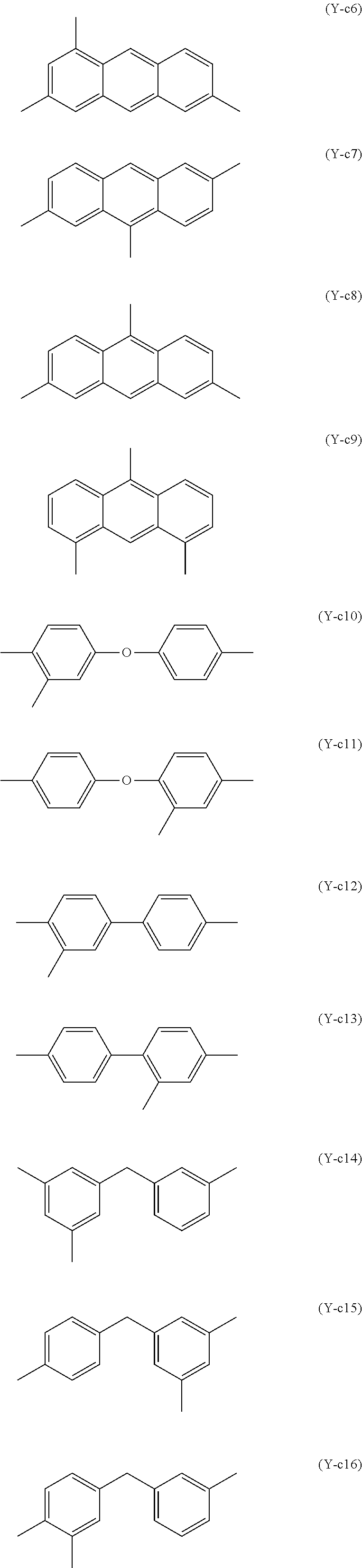

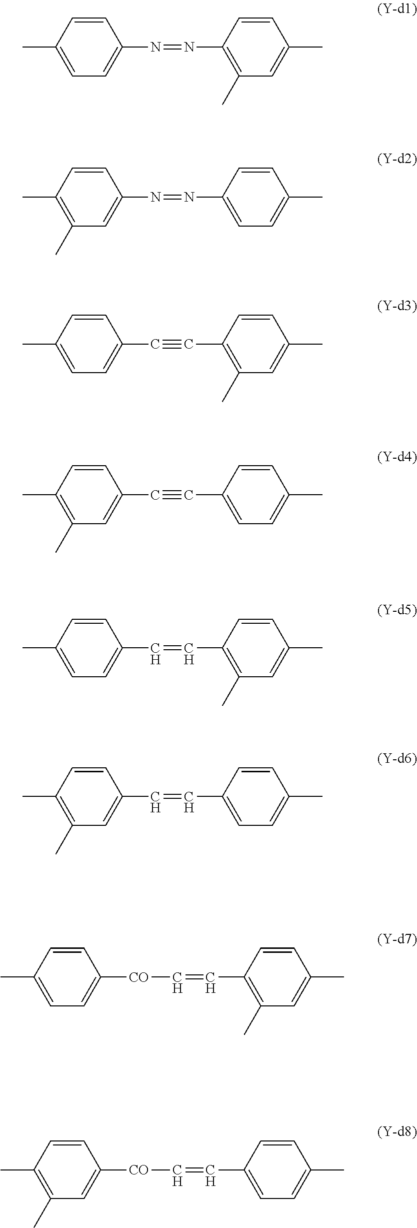

10. The liquid crystal display device according to claim 8,
wherein the liquid crystal alignment layer has a structure derived from a polyimide-based or polyamic acid-based vertical alignment polymer represented by the following structural formula (2′) or (3′): 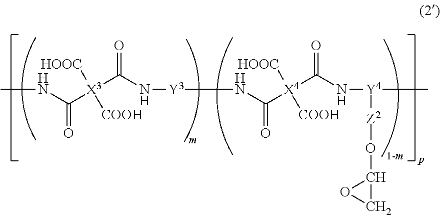
wherein X³ and X⁴ each independently represent any one of the following structural formulas (X-a1) to (X-a13) and (X-b1) to (X-b4), Y³ represents a moiety in which a side chain represented by any one of the following structural formulas (Za-1) to (Z-a21) is bonded to any one of the following structural formulas (Y-c1) to (Y-c16) and (Y-d1) to (Y-d8), Y⁴ represents any one of the following structural formulas (Y-c1) to (Y-c16) and (Y-d1) to (Y-d8), Z² represents a direct bond with an epoxy group or a linear or branched alkylene group having 1 or more and 12 or less carbon atoms, m represents a value of 0 or greater and 0.5 or less, and p represents an integer of 1 or greater, 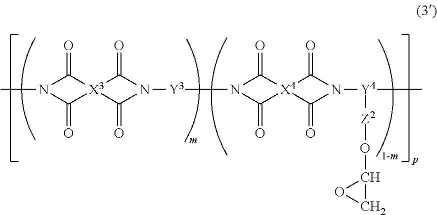
wherein X³ and X⁴ each independently represent any one of the following structural formulas (X-a1) to (X-a13) and (X-b1) to (X-b4), Y³ represents a moiety in which a side chain represented by any one of the following structural formulas (Z-a1) to (Z-a21) is bonded to any one of the following structural formulas (Y-c1) to (Y-c16) and (Y-d1) to (Y-d8), Y⁴ represents any one of the following structural formulas (Y-c1) to (Y-c16) and (Y-d1) to (Y-d8), Z² represents a direct bond with an epoxy group or a linear or branched alkylene group having 1 or more and 12 or less carbon atoms, m is a value of 0 or greater and 0.5 or less, and p represents an integer of 1 or greater,

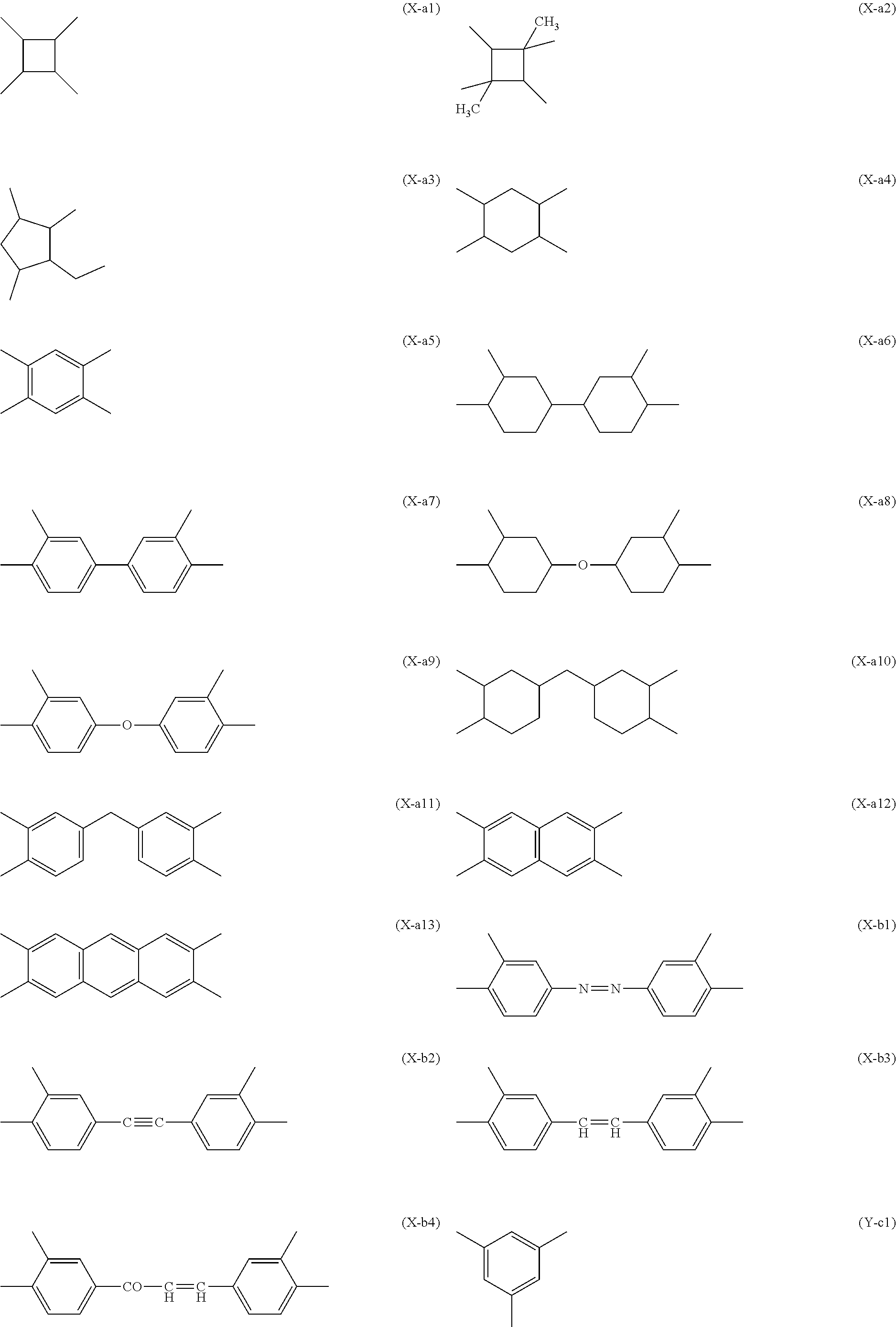

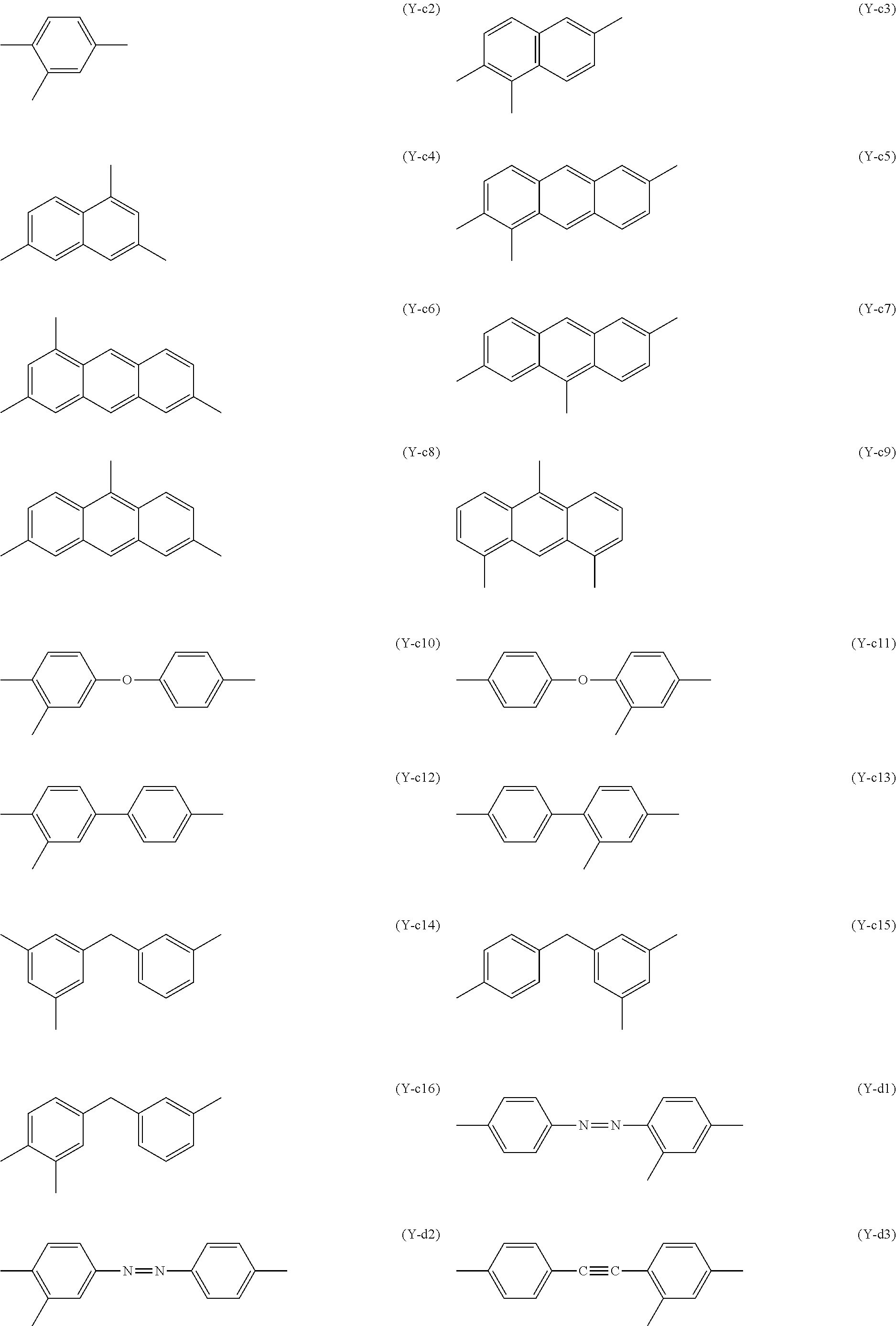

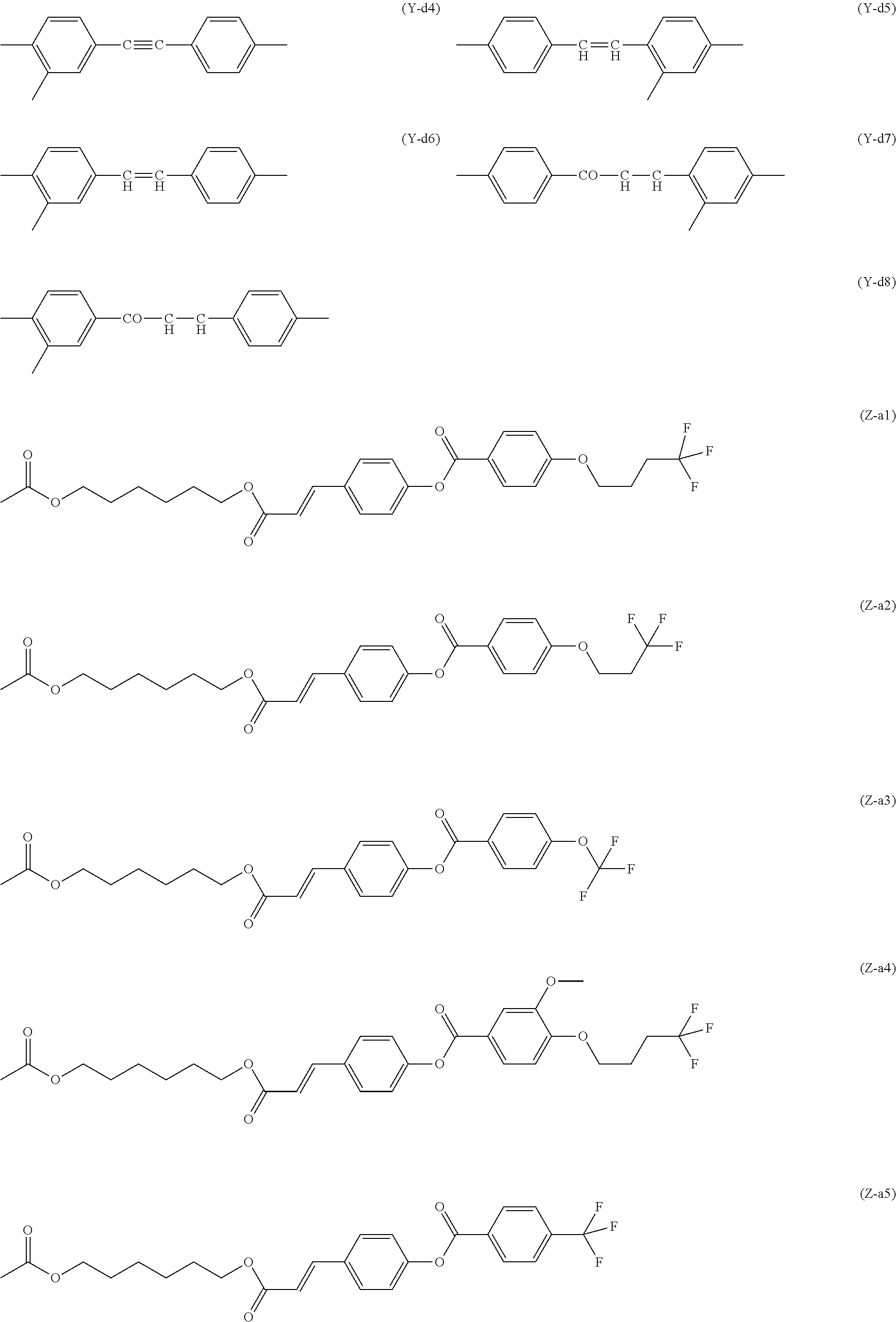

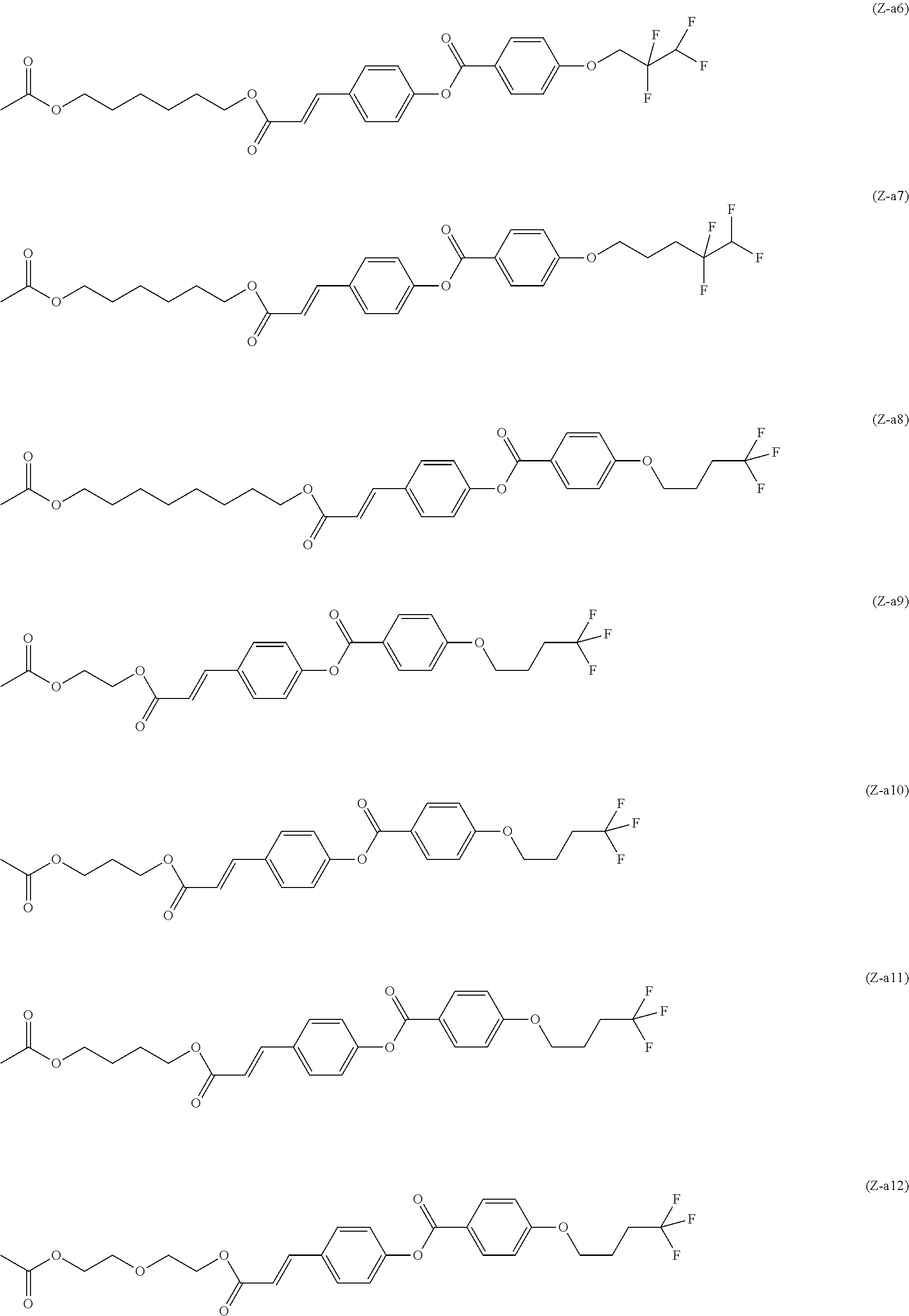

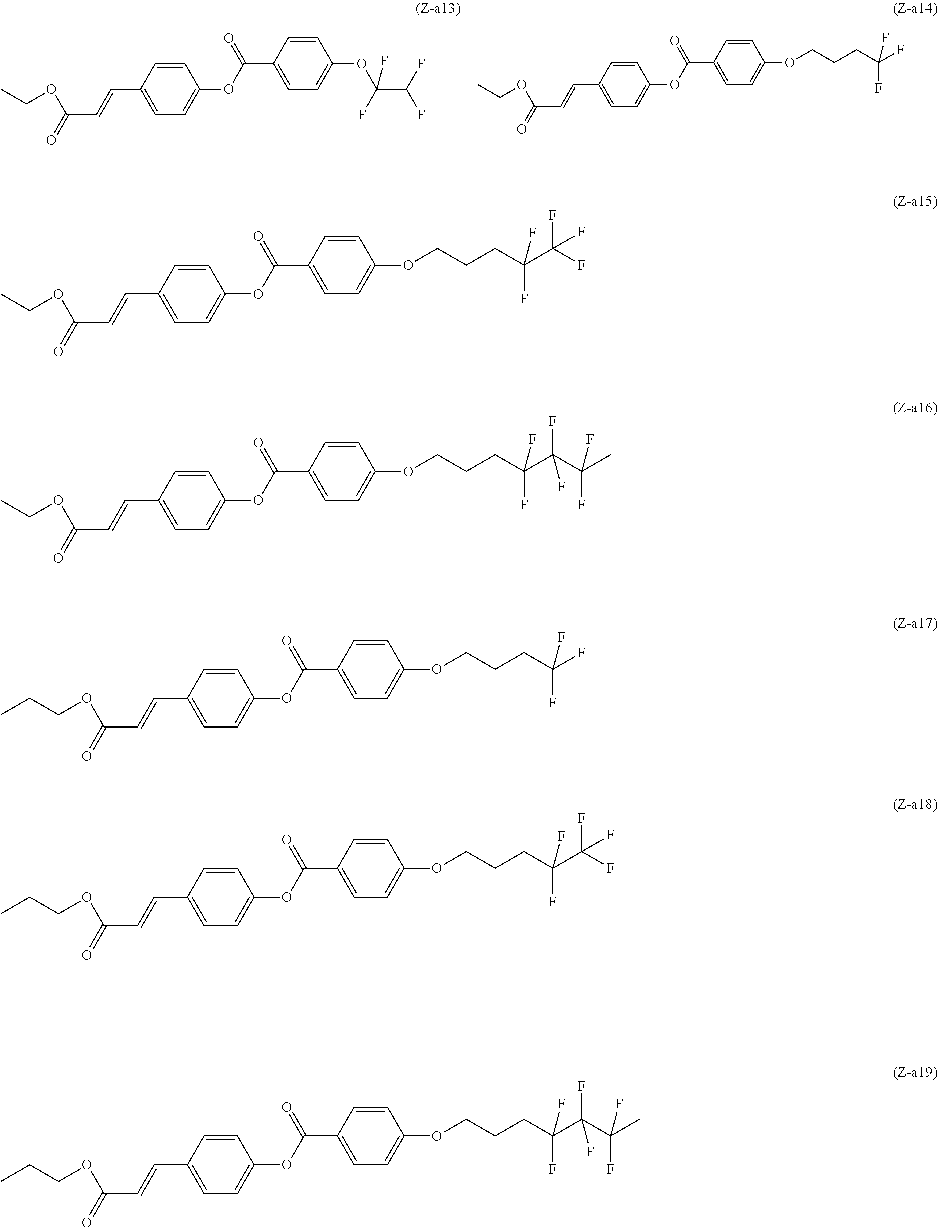

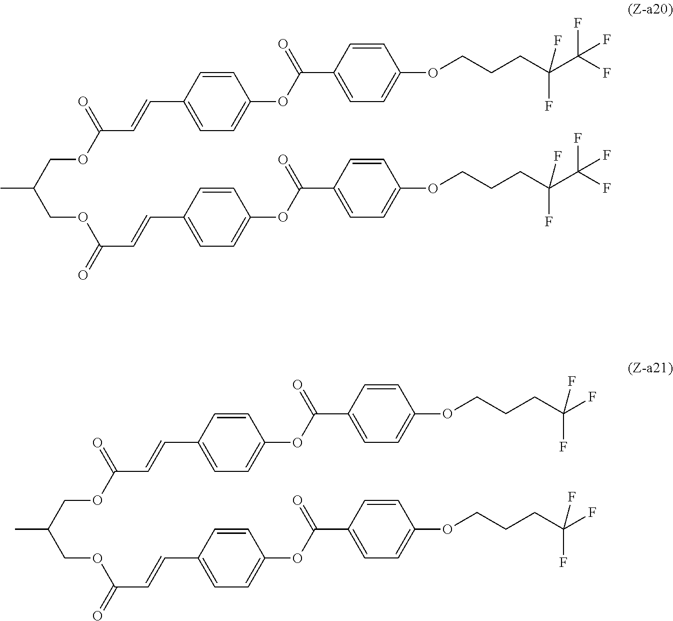 [SMILES: CC(COC(=O)/C=C/c1ccc(OC(=O)c2ccc(OCCCC(F)(F)C(F)(F)F)cc2)cc1)COC(=O)/C=C/c1ccc(OC(=O)c2ccc(OCCCC(F)(F)C(F)(F)F)cc2)cc1 ; CC(COC(=O)/C=C/c1ccc(OC(=O)c2ccc(OCCCC(F)(F)F)cc2)cc1)COC(=O)/C=C/c1ccc(OC(=O)c2ccc(OCCCC(F)(F)F)cc2)cc1]

11. The liquid crystal display device according to claim 8,
wherein the liquid crystal alignment layer has a structure derived from a polysiloxane-based vertical alignment polymer represented by the following structural formula (4) or (5): 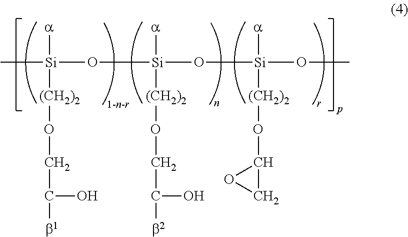
wherein α's each independently represent a hydrogen atom, a methyl group, or a methoxy group, β¹ and β² each independently represent the following structural formula (β-1) or (β-2), n represents a value of 0 or greater and 0.3 or less, r represents a value of greater than 0 and 0.6 or less, and p represents an integer of 1 or greater, 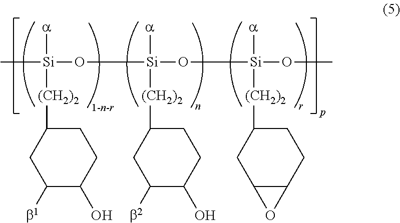
wherein α's each independently represent a hydrogen atom, a methyl group, or a methoxy group, β¹ and β² each independently represent the following structural formula (β-1) or (β-2), n represents a value of 0 or greater and 0.3 or less, r represents a value of greater than 0 and 0.6 or less, and p represents an integer of 1 or greater,

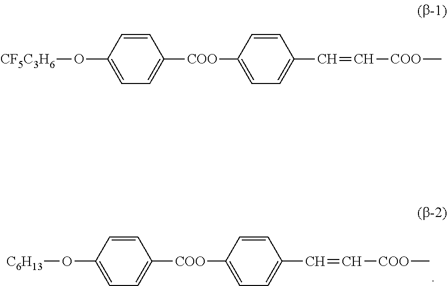

12. The liquid crystal display device according to claim 8,
wherein the liquid crystal alignment layer has a structure derived from a polyacrylic acid-based or polymethacrylic acid-based vertical alignment polymer represented by the following structural formula (6), 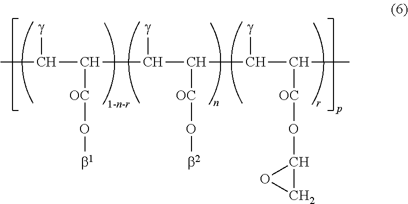
wherein γ's each independently represent a hydrogen atom or a methyl group, β¹ and β² each independently represent the following structural formula (8-1) or (β-2), n represents a value of 0 or greater and 0.3 or less, r represents a value of greater than 0 and 0.6 or less, and p represents an integer of 1 or greater,

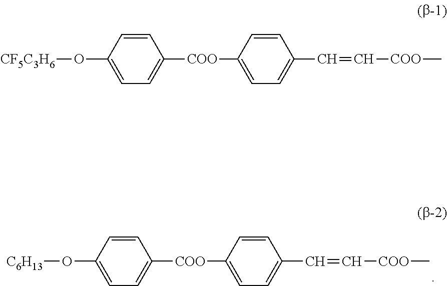

13. The liquid crystal display device according to claim 1,
wherein the base layer has a structure derived from a polyimide-based or polyamic acid-based polymer represented by the following structural formula (7) or (8), 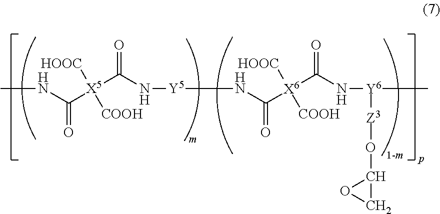
wherein X⁵ and X⁶ each independently represent any one of the following structural formulas (X-c1) to (X-c11), Y⁵ represents any one of the following structural formulas (Y-a1) to (Y-a14), Y⁶ represents any one of the following structural formulas (Y-c1) to (Y-c16), Z³ represents a direct bond with an epoxy group or a linear or branched alkylene group having 1 or more and 12 or less carbon atoms, m represents a value of 0 or greater and 0.5 or less, and p represents an integer of 1 or greater, 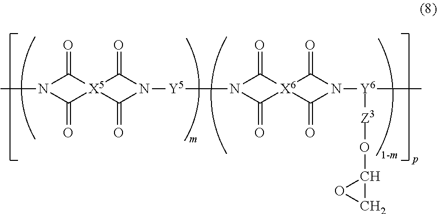
wherein X⁵ and X⁶ each independently represent any one of the following structural formulas (X-c1) to (X-c11), Y⁵ represents any one of the following structural formulas (Y-a1) to (Y-a14), Y⁶ represents any one of the following structural formulas (Y-c1) to (Y-c16), Z³ represents a direct bond with an epoxy group or a linear or branched alkylene group having 1 or more and 12 or less carbon atoms, m represents a value of 0 or greater and 0.5 or less, and p represents an integer of 1 or greater,

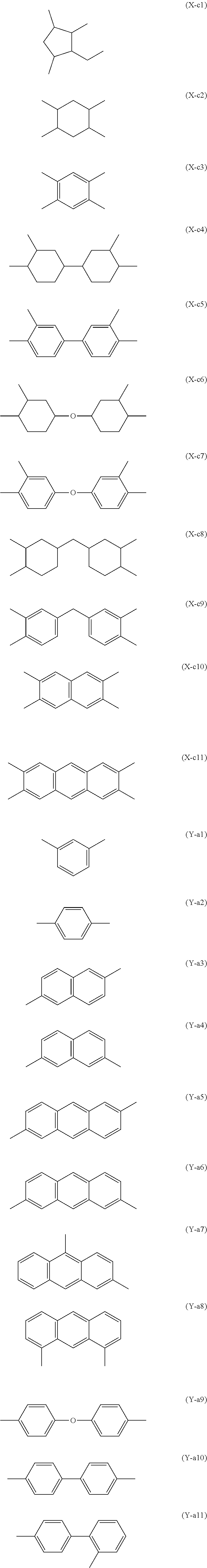

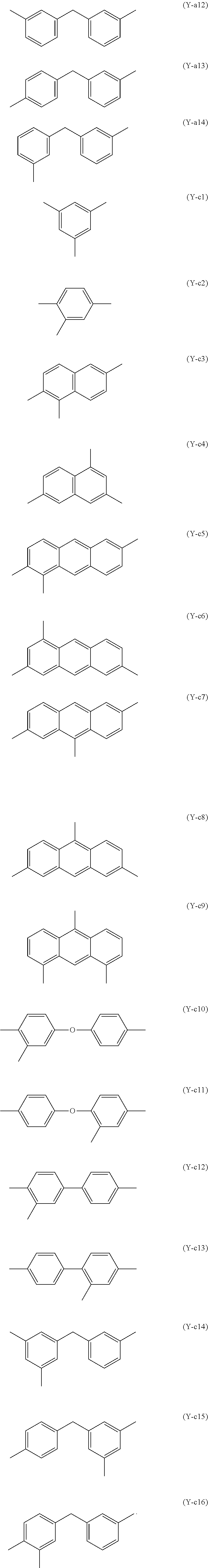

14. The liquid crystal display device according to claim 1,
wherein the base layer has a structure derived from a polyimide-based or polyamic acid-based polymer represented by the following structural formula (7′) or (8′): 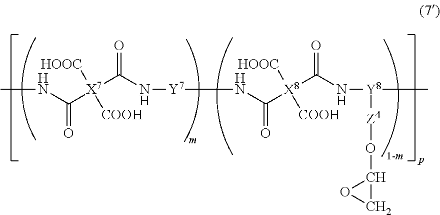
wherein X⁷ and X⁸ each independently represent any one of (X-c1) to (X-c11), Y⁷ represents a moiety in which a side chain represented by any one of the following structural formulas (Z-b1) to (Z-b7) is bonded to any one of the following structural formulas (Y-c1) to (Y-c16), Y⁸ represents any one of the following structural formulas (Y-c1) to (Y-c16), Z⁴ represents a direct bond with an epoxy group or a linear or branched alkylene group having 1 or more and 12 or less carbon atoms, m represents a value of 0 or greater and 0.5 or less, and p represents an integer of 1 or greater, 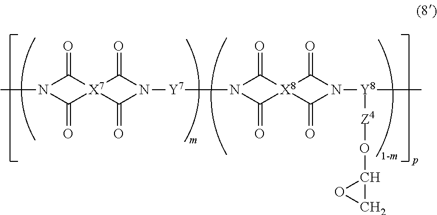
wherein X⁷ and X⁸ each independently represent any one of (X-c1) to (X-c11), Y⁷ represents a moiety in which a side chain represented by any one of the following structural formulas (Z-b1) to (Z-b7) is bonded to any one of the following structural formulas (Y-c1) to (Y-c16), Y⁸ represents any one of the following structural formulas (Y-c1) to (Y-c16), Z⁴ represents a direct bond with an epoxy group or a linear or branched alkylene group having 1 or more and 12 or less carbon atoms, m represents a value of 0 or greater and 0.5 or less, and p represents an integer of 1 or greater, 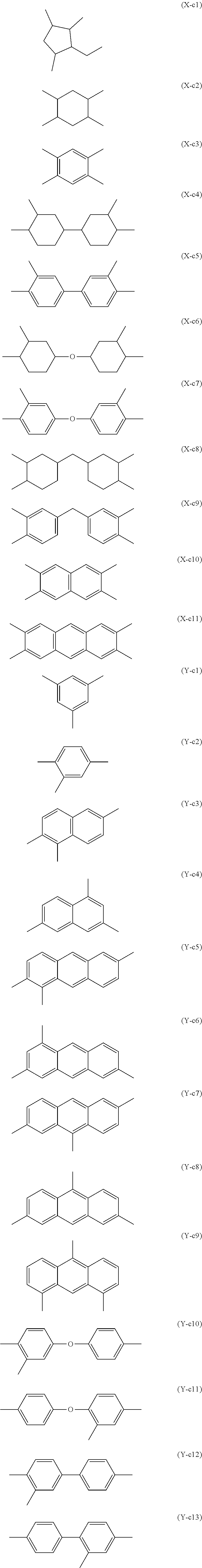 [chemical structure]
